(19) United States
(12) Patent Application Publication
(10) Pub. No.: US 2017/0140072 A1
(43) Pub. Date: May 18, 2017

(54) METHOD AND SYSTEM FOR DETERMINING A CONFIGURATION OF A MODEL HAVING A COLLECTION OF ENTITIES AND SATISFYING A SET OF CONSTRAINTS

(71) Applicant: Masashi KUBOTA, Matsudo-shi, Chiba (JP)

(72) Inventor: Nikolai SIDORENKO, Akko (IL)

(21) Appl. No.: 15/317,129

(22) PCT Filed: Jun. 17, 2015
(86) PCT No.: PCT/IL2015/050613

§ 371 Date: Dec. 8, 2016

Related U.S. Application Data
(60) Provisional application No. 62/013,043, filed on Jun. 17, 2014.

(51) Int. Cl. G06F 17/50; G06F 17/16; G06F 17/11

(52) U.S. Cl. CPC G06F 17/50; G06F 17/11; G06F 17/16; G06F 2217/06

(57) ABSTRACT

A method determines a configuration of a model. The model, includes entities feat satisfy constraints. Variables represent the entities and each constraint, corresponds to constraint equations. The constraints equations interrelate a subset of variables. At least one tree is generated. The tree includes a root node and she root node has at least one child. Nodes having a child node define parent nodes. Nodes lacking child nodes define leaf nodes. Each node corresponds to a subset of the constraint equations. Constraint equations of a subset of leaf nodes are satisfied in parallel. Constraint equations of parent nodes with satisfied child nodes are satisfied based on the satisfied constraint equations of the corresponding child nodes. Constraint equations are satisfied until the constraint equations of the root node are satisfied. Satisfied constraint equations of each parent node are propagated to corresponding child nodes. Entities of the determined configuration are output for display.

### TECHNICAL FIELD

The present invention relates to computer models having a collection of entities and satisfying a corresponding set of constraints.

### BACKGROUND OF THE INVENTION

Soiling constrained systems and models is useful in many industrial applications, such as, for example, computer-aided design (CAD) systems, operations research problems and the like. In typical parametric CAD systems, geometric models are represented by a collection of geometric entities. The entities of the collection of entities are interrelated by a set of constraints, typified by a set of constraint equations. As such, a user modifying entities of the model ideally results in a corresponding modification of related entities in order to satisfy the constraints. This is accomplished by the CAD system software solving the constrained equations of the model. For example, a model of a square may be defined by the entities of four line segments. Examples of constraints of such a model may include: the four line segments being of equal length, two intersecting lines being perpendicular, and appropriate interconnections of line segments at the end points of the line segments. When a user modifies a particular line segment by lengthening the line segment, the three remaining line segments are correspondingly lengthened, in order to maintain the shape of the square.

However, in existing parametric CAD systems, as the number of constraints and entities grow, the number of computations required for solving the constraint equations increases dramatically. As a result, existing parametric CAD systems cannot handle more than a few hundred constraints without negatively affecting the speed and performance of the CAD system. This design limitation leads users to work with smaller models, compromising model complexity for speed and performance of the CAD system.

The present invention is a method and system for providing a functionality for determining the configuration of a model having a collection of entities and satisfying a set of constraints.

According to an embodiment of the teachings of the present invention there is provided, a non-transitory computer-readable storage medium having embedded thereon computer-readable code, the computer-readable code comprising program code for implementing a method for determining a configuration, of a model comprising a collection of entities satisfying a set of constraints, the method comprising: (a) providing the collection of entities and the set of constraints; (b) generating at least one tree, the at least one tree including a plurality of nodes, the at least one tree including a root node, the root node having at least one child node, the nodes having at least one child node defining parent nodes, the nodes lacking child nodes defining leaf nodes, each node corresponding to a subset, of the constraint equations; (c) for a subset of leaf nodes, solving in parallel to satisfy the constraint equations of each of the leaf nodes; (d) for each parent node for which the constraint equations of the child nodes have been satisfied, solving to satisfy the constraint equations of the parent node, based on the satisfied constraint equations of the corresponding child nodes; (e) repeating (d) until the constraint equations of the root node have been satisfied; (f) propagating the satisfied constraint equations of each of the parent nodes to the corresponding child nodes of each parent node, thereby determining the configuration of the model satisfying the set of constraints; and (g) outputting the entities corresponding to the determined configuration.

Optionally, the method further comprises: (h) providing a display organization module; and (i) organizing for display the output entities corresponding to the determined configuration of the model according to the satisfied set of constraints.

Optionally, solving to satisfy the constraint equations of each of the child nodes includes: updating a state vector of the child node; and (ii) generating an updated statistical matrix corresponding to the updated state vector.

Optionally, updating the state vector of each of the child nodes is based on a difference between a first configuration, in which the constraint equations corresponding to the child node are not satisfied, and a second configuration, in which the constraint equations corresponding to the child node are satisfied.

Optionally, satisfying the constraint equations of each parent node includes: (i) predicting a state vector for each of the child nodes of the parent node, each state vector corresponding to the updated state vector of each child node of the parent node; and (ii) generating a predicted statistical matrix corresponding to each of the predicted state vectors.

Optionally, satisfying the constraint equations of each parent node further includes: (iii) combining the predicted statistical matrices of the child nodes of the parent node into a single combined statistical matrix; (iv) generating a combined state vector corresponding to the combined statistical matrix; and (v) updating a state vector of the parent node based on the combined statistical matrix and combined state vector.

Optionally, propagating the satisfied constraint equations of each parent node includes: (i) propagating the updated state vector of the parent nodes to each of the child nodes of the parent node to apply an adjustment, to the updated state vectors of each of the child nodes of the parent node; and (ii) repeating (i) until the updated state vectors of the leaf nodes are adjusted.

Optionally, the method further comprises: repeating (c)-(f) until a first accuracy condition is satisfied.

Optionally, the repeating is iterative.

Optionally, the first accuracy condition is based on a residual vector.

Optionally, the entities are geometric entities.

Optionally, the geometric entities are two dimensional geometric entities.

Optionally, the geometric entities are three dimensional geometric entities.

Optionally, the method further comprises: (h) generating a matrix representative of the model, the matrix having at least a first and second dimension, each of at least one vectors in the first dimension of the matrix corresponding to a subset of the plurality of variables, the matrix being sparse in the first dimension, each node of the at least one tree corresponding to at least one of the vectors in the first dimension of the matrix.

Optionally, the model is a non-linear model.

Optionally, generating the matrix representative of the non-linear model includes: (i) prior to (b), linearizing the non-linear model to produce a linear model; and (ii) repeating (c)-(f) until a second accuracy condition is satisfied.

Optionally, the repeating is iterative.

Optionally, the second accuracy condition is based on a residual vector.

Optionally, the matrix is a sequentially linearized matrix.

Optionally, generating the at least one tree includes: (i) creating a root node of the at least one tree and placing at least one of the constraint equations in the root node; and (ii) placing constraint equations sharing at least one variable with the at least one equation in the root node in respective child nodes of the root node.

Optionally, generating the at least one tree further includes: (iii) placing constraint equations sharing at least one variable with at least one of the constraint equations in the respective child nodes in additional respective child nodes of the respective child nodes; (iv) repeating (iii) until each of the constraint equations is placed in at least one of the nodes of the at least one tree.

Optionally, the model has at least one degree of freedom.

Optionally, the method further comprises: (h) receiving as user input, instructions to modify at least one entity of the collection of entities; and (i) in response to the user input, solving to satisfy the set of constraint equations to determine a new configuration of the model.

Optionally, the method further comprises: (j) outputting the entities corresponding to the Configuration of the model satisfying the set of constraints.

Optionally, solving to satisfy the constraint equations of the parent node, based on the satisfied constraint equations of the corresponding child nodes is done in parallel.

Optionally, the statistical matrices are covariance matrices.

Optionally, the subset of leaf nodes includes all of the leaf nodes.

There is also provided according to an embodiment of the teachings of the present invention, a system for determining the configuration of a model comprising a collection of entities and a set of constraints in a computer having software instructions, the collection of entities represented by a plurality of variables, each constraint corresponding to at least one constraint equation interrelating a subset of the plurality of variables, the system comprising: (a) a computer system, the computer system including at least one processor, and at least one user input device, the computer system configured to: (i) receive user input to generate the model via the at least one input device; (ii) generate at least one tree, the at least one tree including a plurality of nodes, the at least one tree including a root node, the root node having at least one child, the nodes having at least one child node defining parent nodes, the nodes lacking child nodes defining leaf nodes, each node corresponding to a subset of the collection of constraint equations; (iii) for a subset of leaf nodes, solve in parallel to satisfy the constraint equations of each of the leaf nodes; (iv) for each parent node for which the constraint equations of the child nodes have been satisfied, solve to satisfy the constraint equations of the parents, based on the satisfied constraint equations of the corresponding child nodes; (v) repeat (iv) until the constraint equations of the root node have been satisfied; (vi) propagate the satisfied constraint equations of each of the parent nodes to the corresponding child nodes of each parent node, thereby determining the configuration of the model satisfying the set of constraints; and (vii) output the entities corresponding to the determined configuration.

Optionally, the computer system further includes at least one display device, and the computer system is further configured to: (viii) display the output entities, via the at least one display device, of the determined configuration.

Optionally, the computer system is further configured to: (viii) receive user input to modify at least, one entity of the collection of entities; and (ix) solve to satisfy the set of constraints to determine a new configuration of the model.

There is also provided according to an embodiment of the teachings of the present invention, a system for determining the configuration of a model comprising a collection of entities and a set of constraints in a computer having software instructions, the collection of entities represented by a plurality of variables, each constraint corresponding to at least one constraint equation interrelating a subset of the plurality of variables, the system comprising: (a) a computer system, the computer system including a memory, at least one processor, at least one user input device, and at least one display device; and (b) a computer generated model stored on the memory of the computer system, the computer system configured to: (i) receive user input to modify at least one entity of the collection of entities via the at least one input device; (ii) generate at least one tree, the at least one tree including a plurality of nodes, the at least one tree including a root node, the root node having at least one child node, the nodes having at least one child node defining parent nodes, the nodes lacking child nodes defining leaf nodes, each node corresponding to a subset of the collection of constraint equations; (iii) for a subset of leaf nodes, solve in parallel to satisfy the constraint equations of each of the leaf nodes; (iv) for each parent node for which the constraint equations of the child nodes have been satisfied, solve to satisfy the constraint equations of the parent, based on the satisfied constrain equations of the corresponding child nodes; (v) repeat (iv) until the constraint equations of the root node have been satisfied; (vi) propagate the satisfied constraint equations of each of the parent nodes to the corresponding child nodes of each parent node, thereby determining the configuration of the model satisfying the set of constraint; (vii) output the entities corresponding to the determined configuration; and (viii) display the output entities, via the at least one display device, of the determined configuration.

There is also provided according to an embodiment of the teachings of the present invention, a method for determining a configuration of a model comprising a collection of entities satisfying a set of constraints, the method comprising: (a) providing the collection of entities and the set of constraints, the collection of entities represented by a plurality of variables, each constraint corresponding to at least one constraint equation interrelating a subset of the plurality of variables; (b) generating at least one tree, the at least one tree including a plurality of nodes, the at least one tree including a root node, the root node having at least one child, the nodes having at least one child node defining parent nodes, the nodes lacking child nodes defining leaf nodes, each node corresponding to a subset of the constraint equations; (c) for a subset of leaf nodes, solving in parallel to satisfy the constraint equations of each of the leaf nodes; (d) for each parent node for which the constraint equations of the child nodes have been satisfied, solving to satisfy the constraint equations of the parent node, based on the satisfied constraint equations of the corresponding child nodes; (e) repeating (d) until the constraint equations of the root node have been satisfied; (f) propagating the satisfied constraint equations of each of the parent nodes to the corresponding child nodes of each parent node, thereby determining the configuration of the model satisfying the set of constraints; and (g) outputting the entities corresponding to the determined configuration.

There is also provided according to an embodiment of the teachings of the present invention, a computer program that can be loaded onto a server connected through a network to a client computer, so that the server running the computer program constitutes a server in a system according to any of the embodiments described in this document.

There is also provided according to an embodiment of the teachings of the present invention, a computer program that can be loaded onto a computer connected through a network to a server, so that the computer program institutes a client computer in a system according to any of the embodiments described in this document.

### BRIEF DESCRIPTION OF THE DRAWINGS

The invention is herein described, by way of example only, with reference to the accompanying drawings, wherein:

FIG. 1 is a flowchart tor performing a process for determining a configuration of a model having a collection of entities and satisfying a corresponding set of constraints according to an embodiment of the invention;

FIG. 2 illustrates an example of tree having multiple generations;

FIG. 3 is a flowchart of a tree generating process according to an embodiment of the Invention;

FIG. 4 is a flow chart for solving to satisfy constraint equations of a child node according to an embodiment of the invention;

FIG. 5 is a flow chart for solving to safety constraint equations of a parent node according to an embodiment of the invention;

FIG. 6 is a flow chart far adjusting solved constraint equations of a child node according to an embodiment of the invention;

FIG. 7A is a schematic diagram of a generalized representation of an exemplary processing unit for performing the process of FIG. 1;

FIG. 7B is a block diagram, of a computer system housing the processing unit of FIG. 7A;

FIG. 8 illustrates an example of a geometric constraint satisfaction problem;

FIG. 9 illustrates a matrix representative of a linearized system of equations of the geometric constraint satisfaction problem FIG. 8;

FIGS. 10A-10B illustrate a tree generated from the matrix of FIG. 9.

FIGS. 11A-11D illustrate statistical matrices corresponding to state vectors of nodes of the tree of FIG. 10B;

FIGS. 12A-12C illustrate predicted statistical matrices corresponding to state vectors of nodes of the tree of FIG. 10B;

FIGS. 13A-13B illustrate combined statistical matrices corresponding to state vectors of nodes of the tree of FIG. 10B;

FIGS. 14A-14B illustrate index matrices corresponding to the node of the tree of FIG. 10B;

FIGS. 15A-15B illustrate adjustment matrices for adjusting state vectors of nodes of the tree of FIG. 10B.

### DESCRIPTION OF THE PREFERRED EMBODIMENTS

The present invention is a method and system for providing a functionality for determining the configuration of a model having a collection of entities and a set of constraints.

The principles and operation of a method and system according to the present invention may be better understood with reference to the drawings and the accompanying description.

A previously developed method for modeling stochastic processes, referred to as Multiscale Autoregressive estimation (MAR estimation), may be applied to solving systems of linear equations represented by matrices with unique properties. MAR estimation is a generalization of a Kalman filter for time having a complex tree-like structure. In order to apply MAR estimation to solving such systems of linear equations, the stochastic process problem is formulated in terms of numerical calculations. However, the realization of constraint equations in the context of MAR estimation is not straightforward, and relies on the recognition of unique properties of the above mentioned matrices. Accordingly, although many of the individual components may be known in other fields, the embodiments described herein are not straightforward combinations of such components, but are rather synergistic techniques which lend to enhanced results and reduced computational complexity and computation time.

The embodiments disclosed herein are applicable to a variety of models defined by a collection of entities, which satisfy a set of constraints, and are of particular value when applied to CAD systems. In the content of this document, the term “entity” or “entities” generally refers to objects represented by at least one variable, which may be set and modified. In CAD systems for example, the entities are geometric entities of varying dimension. Examples of two-dimensional geometric entities include, but are not limited to, line segments, circles, ellipses, splines, arcs, and the like. Examples of three-dimensional geometric entities include, but are not limited to, planes, spheres, cones, frustums, cubes, cylinders, and the like.

In the context of this document, the term “constraint” or “constraints” generally refers to a restriction on individual entities or on groups of entities. The constraint on an entity of groups of entities is represented by a constraint equation or equations, while entities are represented by corresponding variables. Each constraint equation provides an interrelation between a subset of the variables corresponding to the entities. Once a constraint of a model is set, the constraint should be satisfied regardless of modifications made to entities of the model.

Note that a model may be fully constrained, over-constrained, or under-constrained. This means that the number of constraint equations may be equal to the degrees of freedom of the model (i.e. the number of variables), greater than the degrees of freedom of the model, or less than the degrees of freedom of the model respectively.

Note that in certain systems, constraint equations may contradict each other, and as such, the constraints cannot be maintained. Accordingly, the embodiments disclosed herein are directed to systems of constraint equations which lack contradictions. Furthermore, the embodiments disclosed herein are directed to models which have at least one degree of freedom.

The above mentioned entities are objects in two or three dimensional space and may be represented by a Cartesian coordinate system, such as (x,y) or (x,y,z). Note that the representation of entities may also be accomplished by use of polar coordinate systems. Using polar coordinates may be advantageous in satisfying certain constraints. For instance, constraints which restrict the angles at which a line can be positioned are preferably satisfied by using polar coordinates. Therefore, in a preferred embodiment, the entities are represented by both Cartesian, and polar coordinates. Accordingly, a single line segment is represented by six variables: two x variables, two y variables, a magnitude variable, and an angle variable. According to certain embodiments, solving constraint equations involves selecting which sets variables associated with a model are used in solving the equations.

Throughout this document, mathematical equations and formulas are presented in order to better demonstrate the method and system according to the presented embodiments. In such equations and formulas, matrices are represented by capitalized bold-faced italicized letters (e.g. Q). Vectors are represented by lowercase bold-faced italicized letters (e.g. q). Scalars are represented by lowercase italicized letters (e.g. q). Superscripts of matrices and vectors indicate iterations or realizations of the matrices and vectors. The transpose of a matrix Q is written as Q^{T}. The inverse of matrix Q is written as Q⁻¹.

It is also noted that the indexing of the vectors and matrices described herein begin from zero, as is common with high level programming languages which may be used to implement the embodiments described herein.

Before explaining at least one embodiment of the invention in detail, it is to be understood that the invention in not necessarily limited in its application to the details of construction and the arrangement of the components and/or methods set forth in the following description and/or illustrated in the drawings and/or examples. The invention is capable of other embodiments or of being practiced or carried out in various ways. Initially, throughout this document, references are made to directions such as, for example, up and down, top bottom, and the like. These directional references are exemplary only to illustrate the invention and embodiments thereof.

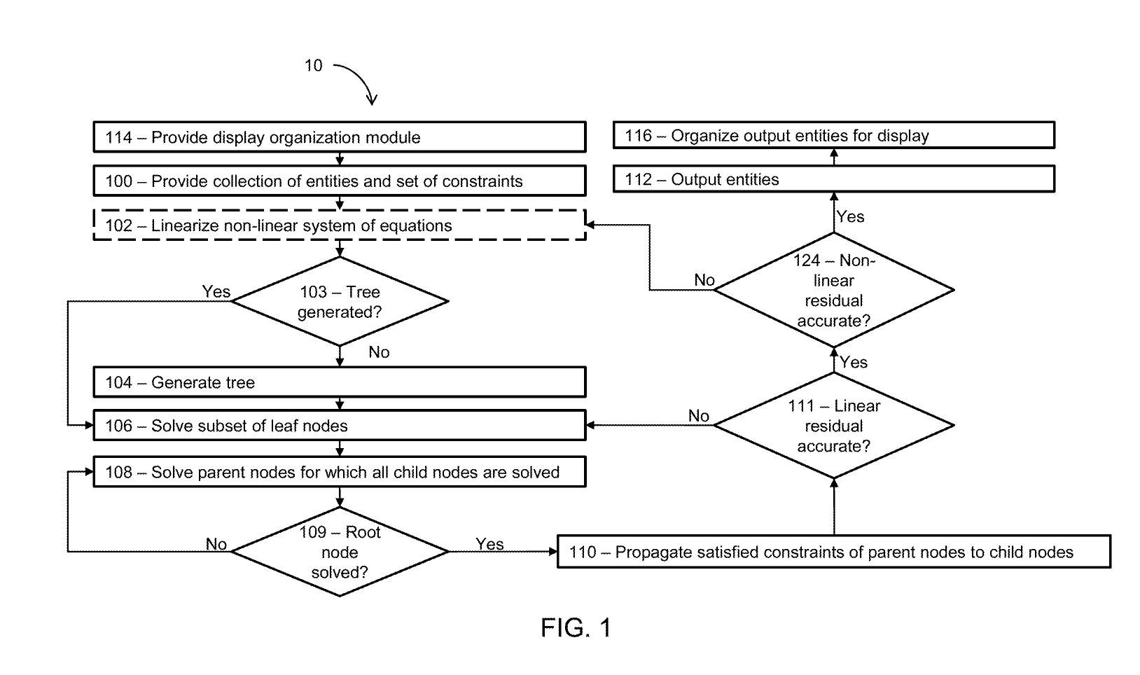

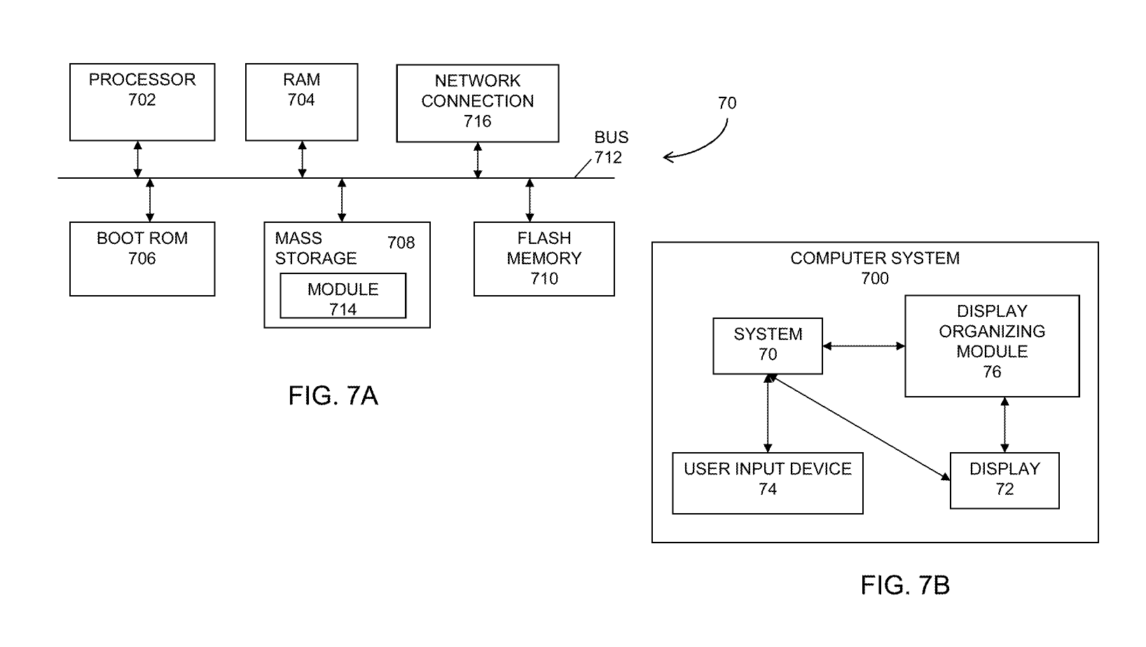

Refer now to FIG. 1, an exemplary flowchart of a process 10 for solving a system of equations representative of a model having a collection of entities and satisfying a corresponding set of constraints. Solving the system of equations of a model is interchangeably referred to herein as determining the configuration of the model or solving the constraint equations of the model. The collection of entities and the corresponding constraints applied to the entities are provided in step 100. The entities add the constraints may be provided by a user through a user input device or loaded from a memory module, as will be discussed with reference to FIGS. 7A and 7B.

As previously mentioned in the contest of CAD systems, geometric models are represented by a collection of geometric entities. The geometric entities may be configured in a variety of ways, with the constraints corresponding to the entities being satisfied in a preferred configuration. Typical geometric entities and constraints are represented by a system of non-linear equations, where the non-linear equations represent a constraint or constraints placed on a group of entities.

Such non-linear systems can be more easily represented as a constraint vector equation F(z)=y, where F(z) is a vector function, z is a vector of variables, describing geometric entities, of the model and y is a “measurement vector” of the non-linear system of constraint equations. A K-length variable vector z has components z₀, z₁, . . . , z_{K-1}. Similarly, an N-length measurement vector y has components y₀, y₁, . . . , y_{N-1}.

Most typically, such systems of non-linear equations are solved by first linearizing the non-linear equations to generate an approximate linear system corresponding to the non-linear system. The system of non-linear equations is linearized to produce a system of linear equations in step 102. A preferred linearization method is an iterative method based on sequential linearization. Accordingly, the above vector function F(z) can be represented as follows:

F(z)=F(z⁰)+A⁰(z−z⁰)+ (1)

Vector z⁰ represents an initial guess of the linear approximation for the first iterative step. Matrix A⁰ is a matrix of partial derivatives of the vector function F(z) evaluated at z⁰, where the i^{th} row and j^{th} column of A⁰ can be represented as follow:

(A⁰)_{i,j}=(ôFᵢ/ôzⱼ)(z⁰) (2)

Preferably, A⁰ is a two-dimensional matrix having N-rows and K-columns. In a preferred embodiment, the rows of A⁰ correspond to the constraint equations of the model, and the columns of A⁰ correspond to the variables of the model.

Since the non-linear system of equations is linearized, on the first iterative step, instead of solving for z of the non-linear system of equations F(z)=y, the linear system A⁰z=y⁰ is solved.

Ignoring the non-linear terms in expression (1), the vector y⁰ can be represented as:

y⁰=y−F(z⁰)+A⁰z⁰ (3)

Note that the system of equations A⁰z=r⁰ may be generally more convenient to solve Than A⁰z=y⁰, where r⁰ is a residual vector of the initial guess vector z⁰.

Accordingly, the residual vector r⁰ can be represented as follows:

r⁰=A⁰z⁰−y⁰=F(z⁰)−y (4)

If the vector z is the solution to A⁰z=r⁰, then the solution z¹ of A⁰z=y⁰ is given by the difference of z⁰ and z, namely z¹=z⁰−z.

Subsequently, on the second linearization iterative step, z¹ is provided as the initial guess. As such, for iteration k+1, the linear system to be solved is A^{k}z=y^{k}, where the matrix A^{k} is a matrix of partial derivatives of the vector function F(z) evaluated at z^{k}, similar to A⁰ in equation (2). Specifically, equation (2) can be generalized to (A^{k})_{i,j}=(∂Fᵢ/ ∂zⱼ)(z^{k}).

Similar to the first non-linear when the non-linear terms of equation (1) are ignored, the vector y^{k} can be represented as y^{k}=y−F(z^{k})+A^{k}z^{k}. Accordingly instead of solving A^{k}z=y^{k}, the system of equations A^{k}z=r^{k} is solved, where r^{k} is the residual vector of the vector z^{k}. Accordingly, the residual vector r^{k} can be represented as follows:

r^{k}=A^{k}z^{z}−y^{k}=F(z^{k})−y (5)

The iterations of the sequential linearization method continue until tile; norm of residual, vector r^{k} is small enough to provide a desired accuracy.

As will he subsequently described, the computational complexity of the solution to the approximate linear system of equations represented by A^{k}z=y^{k} is reduced by using a specific structure of the matrices A^{k}.

For convenience, the general structure and properties of the collection of the matrices A⁰, A¹, A², etc. will be discussed with reference to a matrix A. the present method of solving the constrained system as described herein exploits several properties of the matrix A.

It is herein recognized that A is a sparse matrix. In the context of this document, the term “sparse matrix” generally refers to a matrix in which the majority of the elements of the matrix are zero. In the particular matrices of the present embodiments, the matrix A is sparse row-wise. In other words, the majority of the elements along each row of A are zero. For example, in many typical CAD models, the total number of variables used to represent the entities being on the order of thousands to hundreds of thousands. However, the number of variables used to represent each equation in the system of equations is typically less than 10. This corresponds to a matrix with thousands of columns, yet each row having less than 10 non-zero elements.

As will subsequently be described, the sparseness of the rows of A allows for the solving the linear system of equations using matrices of dimensions much less than the dimensions of A. Since typical operations with matrices involve computationally complex operations, such as, for example, matrix diversions, using matrices of reduced dimension reduces significantly computational complexity.

Note that although the values of the elements of the matrices A⁰, A¹, A², etc. may be Different, the general structure and sparseness of the matrices remains the same from iteration to iteration of the linearization step 102. This means that the locations of the non-zero elements of the matrices, are maintained from iteration to iteration.

Also note that although the method as described thus far has pertained to models having entities and constraints represented by a system of non-linear equations for which iterative linearization is carried out in step 102, other embodiments are possible which the entities and constraints of the models have an inherently linear relationship, and as such, do not require linearization as described in step 102.

To facilitate the exploitation of the sparse properties of the matrices previously described, matrix A is represented as a tree or as a forest including a plurality of trees.

With continued referenced to FIG. 1, the representation of the relevant matrix as a tree or a forest is shown in step 104. As will be subsequently described in more detail, the representation of the matrix as a tree or collection of trees facilitates efficient, accurate, and reduced computational complexity in solving the approximated linear system of equations.

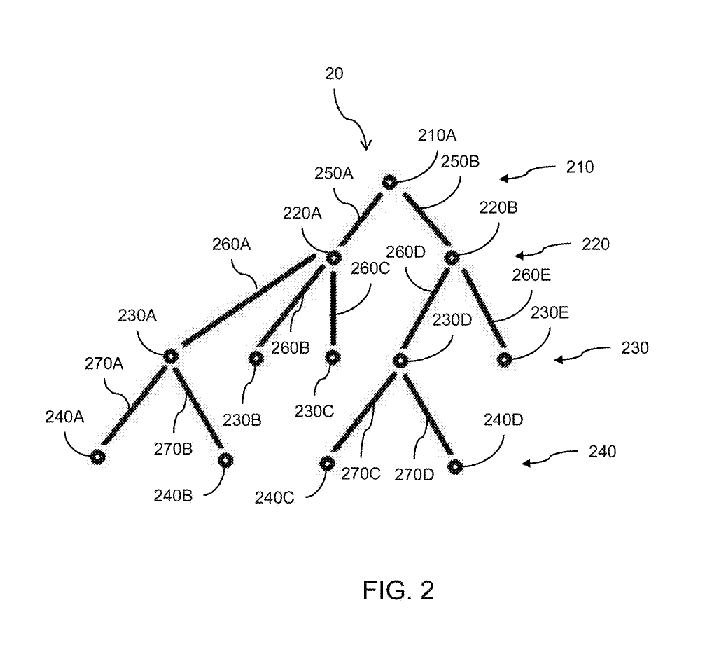

Refer now to FIG. 2, an example of a tree 20. The tree 20 includes a plurality of nodes 210A, 220A-220B, 230A-230E and 240A-240D. The nodes of the tree 20 are connected by a plurality of branches 250A-250B, 260A-260E and 270A-270D. The nodes of the tree 20 include a root node 210A and a plurality of child nodes 220A-220B, 230A-230E and 240A-240D. In the context of this document, the term “root node” generally refers to the node front which all other nodes of a tree descend. In the context of this document, the term “child node” or “children” generally refers to the nodes which descend, directly or indirectly, from the root node.

In the context of this document, the term “parent node” generally refers to the node from which a child node directly descends from. For example, the parent node of the child node 220A is the root node 210A and the parent node of child node 240C is the node 230D. Note that each child node has only a single parent node. Conversely, each parent node can have more than one child node. For example, the node 230D has two children: the child node 240C and the child node 240D. In the context of this document, the term “leaf node” generally refers to a node which lacks children. For example, the nodes 230B-230C, 230E and 240A-240D and are leaf nodes. As should be apparent, a root node lacks a parent node.

It should be apparent that the naming convention and structure of the tree 20 is generally similar to that of a human family tree, and the naming convention used to describe the relationships between nodes of a tree is generally similar to the naming convention used to describe the relationships between members of a family tree.

In the context of this document, the term “sibling node” generally refers to nodes which share a parent node. For example, the nodes 240A and 240B are sibling nodes. In the context of this document, the term “grandparent node” generally refers nodes which are the parent node of the parent node of a child node. For example, the grandparent of the node 240A is the node 220A. In the context of this document, the term “grandchild node” generally refers to a node that is a child node of a child node. For example, the node 240A is a grandchild of the root node 220A, and the node 230B is a grandchild of the root node 210A.

From the above definitions, similar definitions of great-grandparent, great-great-grandparent, etc. should be apparent to one of ordinary skill in the art. In the context of this document the term “ancestor node” or “ancestor” generally refers to a node from which another node descends, either directly or indirectly. For example, the root node 210A is an ancestor node of each of the nodes 220A-220B, 230A-230E and 240A-240D, and the node 220B is an ancestor node of the nodes 230D, 230E, 240C and 240D.

As should be apparent, the generated tree has an inherent generational structure, with the oldest generation of nodes being situated at the top of the tree and the youngest generation of nodes being situated at the bottom of the tree. As such, as the progression is made from the top (i.e. the root node) of the tree towards the bottom of the tree, the generations of the nodes become younger. Similarly, as the progression is made from the bottom of the tree towards the top of the tree, the generations of the nodes become older. The generational structure of the generated tree is better understood with reference to the example of the tree 20.

With continued reference to FIG. 2, tree 20 has four generations of nodes. A first generation 210 of nodes preferably includes only the root node 210A, situated at the top of the tree structure. A second generation 230 of nodes preferably includes all of the child nodes for which the node of the first generation 210 is a parent. In the example of the tree 20, the second generation 220 of nodes includes the nodes 220A-220B. A third generation 230 of nodes preferably includes all of child nodes for which the nodes of the second generation 220 are parents. In the example of the tree 20, the third generation 230 of nodes includes the nodes. 230A-230D. A fourth generation of nodes 240 preferably includes all of the child nodes for which the nodes of the third generation 230 are parents. In the example of the tree 20, the fourth generation 240 of nodes includes the nodes 240A-240D.

Each node of the tree which is generated, or equivalently constructed, in step 104 corresponds to a constraint equation or equations, and analogously a row or several rows, of the linear system of equations.

The tree is generated in a manner such that the tree satisfies several necessary conditions as well as several preferable conditions. The necessary conditions provide convergence of the process as will be described in more detail below. Accordingly, one such necessary condition requires that the constraint equations corresponding to a particular node and the parent node of the particular node be linearly independent.

Furthermore, the following two necessary conditions correspond to the structure of the tree. The first necessary condition corresponding to the structure of the tree requires that if a variable corresponding to an entity is represented in a particular node and an ancestor of the particular node, the same variable is also represented in the intermediate nodes between the ancestor node and the particular node. For example, if a variable is represented in the leaf node 240A and the root node 210A, the same variable is preferably represented in the nodes 220A and 230A.

The second necessary condition on the structure of the tree requires that any variable represented in two nodes which descend from two different branches are also represented in all of the parent nodes between the two nodes up to and including the common ancestor of the two nodes. For example, if a variable is represented in the nodes 240A and 230C, the same variable is preferably represented in the nodes 230A and 220A. In another example, supposing that a variable is represented in the nodes 240A and 240C, the same variable is preferably represented in the nodes 230A, 220A, 230D, 220B and 210A.

With regard to the preferable conditions, if is preferred that the tree includes a relatively large number of branches. As a result, a larger number of branches allows for computations on multiple nodes to be carried out in parallel. The advent of parallel computing techniques, such as, for example, multi core processors and cloud computing systems, facilitate the exploitation of this preferred tree structure.

Furthermore, it is preferred that the tree is constructed such that, in addition to satisfying the above mentioned necessary conditions, each node represents a relatively small number of constraint equations. In a most preferred form, each node represents a single constraint equation. The number of variables in each node is preferably relatively small (while the number of nodes in the tree may be relatively large). This preferred condition also contributes to reduced computational complexity as previously mentioned.

The relatively small number of variables, in each node allows for the use of matrices of reduced dimension in order to reduce computational complexity. As previously mentioned, in typical CAD models, the number of variables used to represent each constraint equation in the system of equations is typically less than 10. As a result, the matrices used for matrix operations, in particular matrix inversion, are smaller than 10 by 10 matrices.

Supposing that the maximum number of variables in each node is less than a fixed number d, the computational complexity for solving the system of equations using the process 10 is approximately O(Nd³). Accordingly, the computational complexity increases linearly with the number of equations in the system of equations. Therefore there is a linear O(N) growth of computational complexity with the growth of the number N constraint equations.

Note that the above estimate for computational complexity is done without taking into account the parallelization of calculations. The calculations on different branches of the tree may be done in parallel. For most regular trees, such as, for example, dyadic trees, the maximal length of a branch may be approximately O(log(N)), and thus for such trees the growth of complexity is approximately O(log(N)).

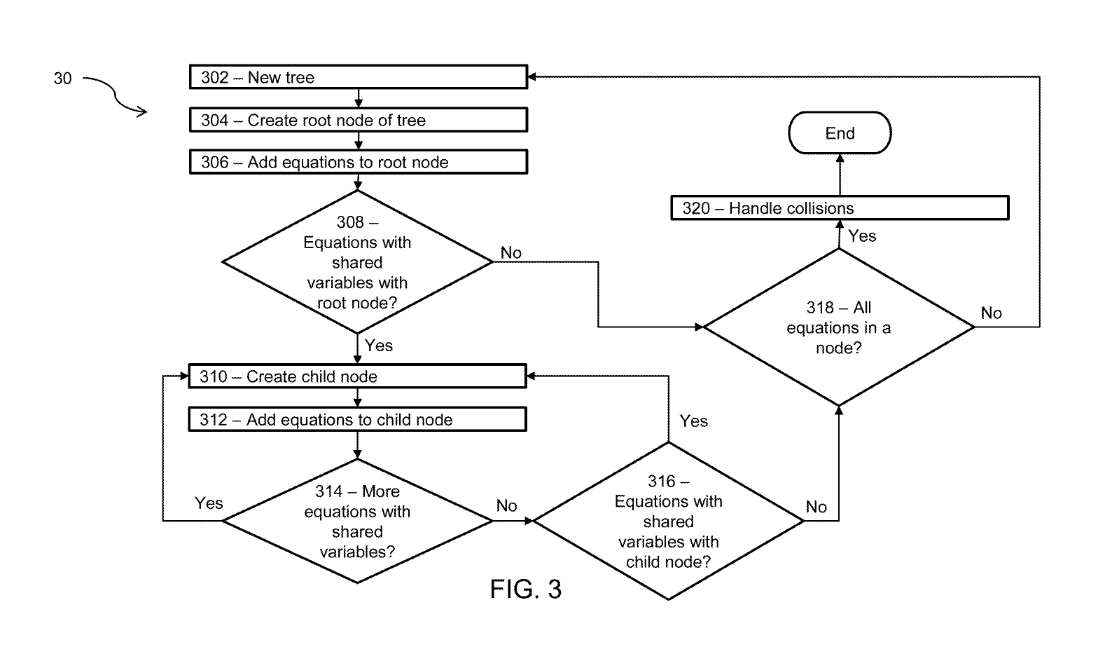

Refer new to FIG. 3 a non-limiting exemplary flowchart of a tree generating process 30 for generating a tree according to step 104. The tree generating process 30 is an example of a process for generating tree, which satisfies the above mentioned conditions. Note there may be other methods for generating trees, which satisfy the mentioned conditions, and the process 30 is only an exemplary process for tree generation.

A result of the process 30 is the placement of constraint equations of the matrix A at nodes of the generated tree. For the purposes of the description of the process 30, constraint equations are denoted by lowercase bold-faced italicized underlined letters (e.g. e).

Nodes of the generated tree are denoted by lowercase italicized subscripted letters. In the example below, all nodes contain only one constraint equation. For convenience, a particular node and the equation placed in that particular node share the same index value. For example, if the first equation e₀ is placed in the root node, the root node is denoted by s₀.

The equations include a subscript, which corresponds to the row of the matrix A. The set of variables of an equation are denoted by capitalized bold-faced italicized underlined letters (e.g. W). The set of variables corresponding to i^{th} equation eᵢ is denoted by Wᵢ. As shorthand notation, the equation of a node can be written as a function of the equation variables as eᵢ(Wᵢ).

As previously mentioned, in a preferred embodiment the equations correspond to the rows of the matrices A^{a}, A¹, A², etc., referred to in general as the matrix A. Recall that the matrix A has N-rows and K-columns, where N is the number of constraint equations and K is the number of variables. The phrase “putting an equation in a node” or “placing an equation in a node” refers to the act of associating a constraint equation with a specific node. Note that the set of variables of a node may be interchangeably referred to as a vector of variables of a node or as a “state vector” of a node.

In step 302, a new tree is created. In step 304, a root node is created in the tree created in step 302, and a constraint equation is placed in the root node. Note that any equation from the matrix can be placed, in the root node in step 304. Supposing that an equation eᵢ(Wᵢ) placed in the root node created in step 304, a next step 306 is to determine if there are other equations which can be placed in the root node as well.

If there are other particular equations having the set of variables Wⱼ for which Wᵢ is a subset of Wⱼ, or for which Wⱼ is a subset of Wᵢ, the equations associated with the set of variables Wⱼ placed in the root node along with any extra variables corresponding to the other particular equations.

Subsequently, the remaining constraint equations are checked tor whether any of the subsequent equations share any variables with the root node. The set of such equations is referred to as set G. If G is not empty (i.e. there is at least one other equation sharing some variables with the root node), a child node of the root node is created for one of the equations with shared variables, and the equation is placed in the child node of the root node. The creation of the child node and placement of such a constraint equation in the child node is done in step 310. Subsequently, similar to step 306, the remaining equations of set G are cheeked for the subset condition with the variables of the child node. Any of the equations of set G which satisfy the subset condition, are added to the child node in step 312. Note that if G is an empty, the tree generating process 30 checks whether all of the equations are represented in the tree. Checking whether set G is empty is done in decision step 308.

Once all constraint equations satisfying the subset condition have been added to the particular child node in step 312, more child nodes of the root node can be created. Step 314 checks whether there are any more equations in the set G not represented by the previously created child node. If there are, a new child node of the root node is created, and one of the equations in G is placed in this new child node. This is equivalent to checking whether there are any more equations in set G sharing variables with the root node. If there are no more such equations, all of the children of the root node have been created, and the process 30 moves on to creating the child nodes of the children of the root node.

Step 316 is similar to step 308. However a new set G for each of the child nodes is created. Accordingly, for each child node, if the corresponding set G is not empty (i.e., there is at least one other equation sharing some variables with the child node), a child node of the child node (step 310) is created and one of the equations with shared variables is placed in the child node of the child node. As such, steps 308-314 are repeated until the child node of all children of the root node have been created with all associated equations placed in each node all generations of nodes have been created with all associated equations placed in each node.

Note that at any point if the relevant set G is empty, the process moves to step 318. In step 318, the constraint equations of the matrix are checked for placement in any of the previously created nodes of the tree. If all of the equations of the matrix are accounted for in the nodes of the tree, the process 30 moves onto final step 320. If however, not all of the equations are accounted for, a new tree is created (step 302), and the subsequent steps 304-318 are repeated for the new tree. This results in the system as a forest of trees. Note that each tree of the forest may be processed independently, and as such may decrease computational complexity.

As a result of steps 302-318, a tree may be constructed in which all of the above mentioned necessary conditions are satisfied. Specifically, an equation variable in a particular node and an ancestor of the particular node may not necessarily be in the equations of all intermediate nodes. Furthermore, an equation variable placed in two nodes, which descend from two different branches, may not be placed in all of the parent nodes between the two nodes up to and including the common ancestor of the two nodes. The above mentioned situations are referred to hereinafter as “collisions”. Collisions are handled in step 320.

Accordingly, if an equation variable in a particular node and an ancestor of the particular node is absent from any of the intermediate nodes, the variable is added to the state vectors of such intermediate nodes. Likewise, if an equation variable in two nodes, which descend from two different branches, is absent from any of the parent nodes between the two nodes up to and including the common ancestor of the two nodes, the variable is added to the state vectors of such nodes.

Note that the collision handling in step 320 is a brute force approach which may be ideal in certain situations. However, situations may arise in which the handling of collisions as described in step 320 may lead to a large number of variables being added to nodes in multiple generations of the tree. In such situations, other collision handling methods may be preferable in order to avoid increased computational complexity

As previously mentioned, in step 104, the relevant matrix is represented as a tree or as a forest including a plurality of trees. The number of trees representative of the matrix is a function of the structure of the matrix. Specifically, the number of trees is a function of the constraint equations relating the entities and the constraints, as discussed with reference to the tree generating process 30.

It is noted, herein that since the general structure and sparseness of the linearized matrices do not change from iteration to iteration of step 102 as previously mentioned, generating the tree or forest in step 104 needs to be carried out only once. However, the values of the variables associate with the entities change from iteration to iteration of step 102, and as such, the nodes of the tree or trees generated in step 104 correspond to the elements in the rows of linear system of equations represented by matrices A⁰, A¹, A², etc. This is depicted in a decision step 103. After the first linearization iteration of step 102, the tree has not yet been generated, and as such, the tree is generated according to step 104. In subsequent linearization iterations of step 102, the tree has already been generated, and as such, the tree generation step 104 is skipped.

Although not explicitly depicted in step 102, the linearization process also includes normalization of the linearized system of equations. Typically, normalization involves dividing the initial guess vector by a certain value, preferably the maximum absolute value of the values of the initial guess vector. This ensures that the values of the initial guess vector are bounded between −1 and 1. As a result of normalization, calculated values based on the normalized linearized matrices yield results which do not blow up to large numbers which may cause accuracy and memory allocation problems. Note that the previously mentioned normalization technique is only one of a variety of normalization techniques, which may be used to keep the resulting calculated values from becoming exceedingly large.

As previously mentioned, embodiments are possible in which the entities and constraints of the models have an inherently linear relationship, and as such, do not require linearization as described in step 102. However, there may be benefits to normalize inherently linear models, and as such, normalization similar to as discuss above is also preferable in such embodiments.

The method for solving the approximated linear system of equations using the tree structure generated in step 104 operates by satisfying the constraint equations of a subset the leaf nodes and progressively satisfying the constraint equations of parent nodes until the constraint equations of the roof node are satisfied. Once the constraint equations of the root node are satisfied, the solution for each satisfied node, beginning from the root node, is propagated down to the leaf nodes through each of the child nodes of the tree.

Refer again to FIG. 1, steps of satisfying the constraint equations of the nodes of the tree. The steps are described with reference to the tree 20 of FIG. 2 unless expressly stated otherwise. As previously mentioned, each node of the tree corresponds to at least one constraint equation, and analogously at least one row of the matrix representing the linear system of equations.

Beginning with a subset of the leaf nodes, the constraint equations of each node in the subset of leaf nodes is solved in step 106. The process in which the constraint equations of a node are solved may be referred to interchangeably as solving to satisfy the constraint equations of a node, solving a node, or as performing a “measurement update” on anode.

In a preferred but non-limiting implementation, the subset of leaf nodes includes all leaf nodes, and is most preferably identically equal to the set of all leaf nodes. In the example of the tree 20, the preferred subset of leaf nodes includes nodes 240A-240D, 230B-230C and 230E. As should be apparent, the leaf nodes can be solved in parallel, reducing the computation time for solving the overall system of equations.

Once the constraint equations of each node of the subset of leaf nodes has been satisfied, the task is to satisfy the constraint equations of the corresponding parent nodes, based on the measurement updates of the corresponding child nodes. A corresponding parent node may be solved after all of the child nodes of the parent node have been solved. This is performed in step 108. Note that a set of parent nodes for which all of the corresponding child nodes have been solved may be solved in parallel. In the example of the tree 20, the parent nodes to be solved in step 108 are the parent nodes 230A and 230D. Note that solving to satisfy the constraint equations of a parent node based on the measurement updates of the corresponding child nodes is referred to interchangeably as performing a prediction for the solution of the parent node based on the measurement updates of the corresponding child nodes. In other words, the solution of the parent node 230A is predicted based on the solutions of the child nodes (leaf nodes) 240A-240B. The predicted solutions of the parent nodes are used as a basis for solving the parent nodes.

As should be apparent, the process of solving the nodes of the tree described in steps 106 and 108 begins with all leaf nodes and progresses to the next generation of nodes. Note that a particular parent node may be solved as soon as all of the child nodes of the particular parent node are solved. Therefore, waiting for nodes to be solved, which are not child nodes of the particular parent node, is not necessary.

Step 108 is repeated until the root node of the tree is solved. As such, after each execution of step 108, a decision step 109 is executed to determine the subsequent step based on whether or not the root note has been solved. If the root node has not yet been solved, step 108 is repeated. If the root node has been solved, the process 10 moves on to step 110.

The process of executing the steps and 106, 108 and 109 may be referred to collectively as performing a “fine-to-coarse update” on the nodes of the tree. Accordingly, in the “fine-to-coarse update” direction of moving along the tree is from the leaf nodes of the tree to the root node of the tree. Step 110 may be referred to as performing a “coarse-to-fine update”. Accordingly, in the “coarse-to-fine update”, the direction of movement along the tree is from the root node to the leaf nodes.

In step 110, the solution of the root node is propagated down to each of the child nodes in the tree. The solution of the root node is used to correct, or equivalently to adjust, the solution of the children of the root nodes. The adjusted solutions of the children of the root nodes are used to adjust the solutions of the grandchildren of the root node. The propagation is continued until the solutions of all of the leaf nodes have been adjusted. In the example of tree the 20, the solution of the root node 210A is used to adjust the solutions of the nodes 220A-220B. In turn, the adjusted solution of the node 220A is used to adjust the solutions of the nodes 230A-230C. Similarly, the adjusted solution of the node 220B is used to adjust the solutions of the nodes 230D-230E. Finally, the adjusted solutions of the nodes 230A and 230D are used to adjust the solutions of the nodes 240A-240B and 240C-240D, respectively. As should be apparent, the solution of the root node propagates through each of the child nodes of the tree until reaching all of the leaf nodes.

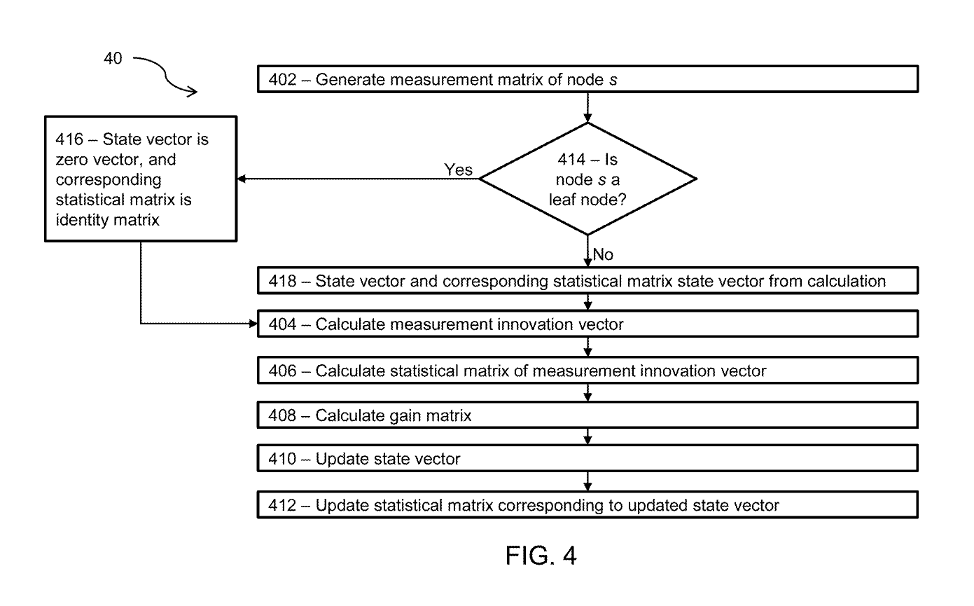

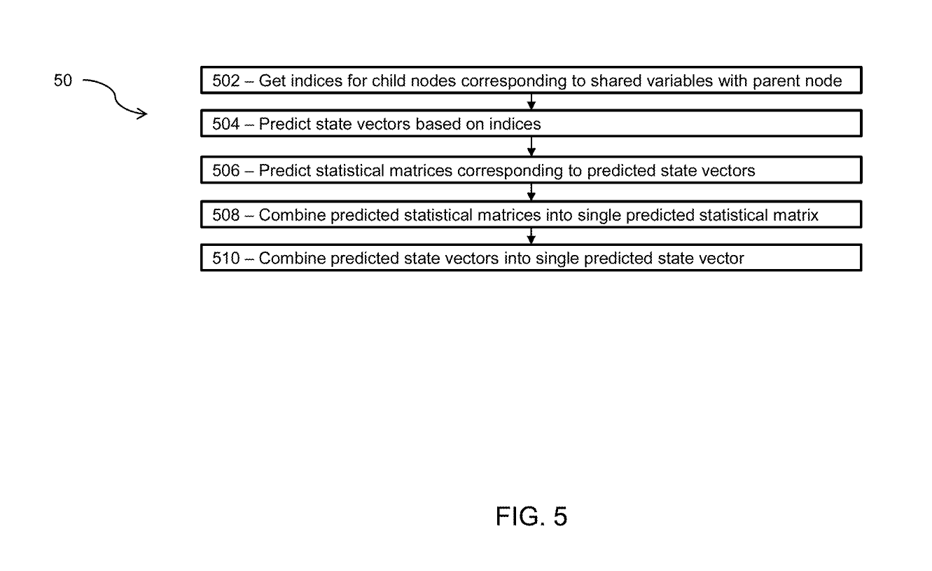

Refer now to FIGS. 4 and 5, flowcharts of exemplary processes 40 and 50 for carrying out the steps 106 and 108. As previously mentioned, the result of step 106 is that a subset of leaf nodes, preferably all of the leaf nodes, is solved. Accordingly, the process 40 performs the measurement updates for such leaf nodes in step 106, as well as the subsequent measurement updates for the parent nodes of the tree based on the updated child nodes in step 108. The steps of the process 40 are herein described for a single node s. The process 40 is carried out for all remaining nodes, and will be understood by analogy thereto unless expressly stated otherwise. The processes 40 and 50 as will be described are based on calculated matrices and vectors corresponding to each node. As such, for a given node s, a matrix M corresponding to the node s is written as M(s). Similarly, a vector b corresponding to the node s is written as b(s). Moreover, the calculated matrices of the processes 40 and 50 are statistical matrices. In the context of this document, the term “statistical matrix” generally refers to a matrix which provides statistical information about the elements of the vector(s) from which the matrix is derived. In other words, the matrix element in the i^{th} row and j^{th} column represents statistical information about the i^{th} and j^{th} elements of the vector(s) from which the matrix is derived. In particularly preferred embodiments, the statistical matrices are covariance matrices, and as such, the statistical information in the i^{th} row and j^{th} column represents the covariance between the i^{th} and j^{th} elements of the vector(s) from which the covariance matrix is derived.

It is noted that in the subsequent sections of this document, matrices and vectors having a subscript of 2 (e.g. Q₂ and q₂) and are used for performing the measurement updates previously mentioned to generate updated matrices and vectors. The resulting updated matrices and vectors are denoted by matrices and vector without any subscripts, and are used for performing the prediction/previously mentioned to generate predicted matrices and vectors. The resulting predicted matrices and vectors are denoted by matrices and vectors having a subscript of 1 (e.g. Q₁ and q₁).

In step 402, a “measurement matrix” C(s) is generated for each node s for which the process 40 is performed. The measurement matrix is obtained from the linearized matrix A by selecting the rows of the linearized matrix, which correspond to the constraint equation(s) of the node s, with all columns corresponding to variables not included in node s removed.

In general, the measurement matrix of each node is of size m by p, where m is the number of constraint equations, which correspond to the node s, and p is the number of variables included in the node s. If m is equal to one, the p is equal to the number of non-zero entries in the row corresponding to the node s.

In step 404, a “measurement innovation” vector v(s) is calculated. The vector v(s) is based in part on the components of the measured output vector y corresponding to the node s, written as y(s). As should be apparent, y(s) is of size m by 1. The vector v(s) is also based in part on a state vector x₂(s) of the node s. The state vector x₂(s) is of size p by I. The state vector x₂(s) is representative of the solution of the node s at a given instant. As previously mentioned, since the process 10 involves ascending the tree from the leaf nodes to the root node, and subsequently descending the tree from the root node to leaf nodes, the state vectors of the nodes are dynamic. The values of the state vectors at the end of the process 10 are the ultimate solutions to the nodes. In a decision step 414, the decision of whether the process 40 is performed on a leaf node or a parent node is made. If the process 40 is performed on a leaf node, the state vector x₂(s) is all zero vector, as shown in step 416. If the process 40 is performed on a parent node, the state vector x₂(s) is a calculated vector, as shown in step 418. The calculated state vector is calculated by the process 50 as will be subsequently described.

The vector v(s) can be represented as follows:

v(s)=y(s)−C(s)x₂(s) (6)

It should be apparent that v(s) is also of size m by I. The innovation vector v(s) is essentially an error vector which describes the difference between a configuration in which the constraint equations of the node s are satisfied, and a configuration in which the constraint equations of the node s are not satisfied.

A statistical matrix, most preferably a covariance matrix, V(s) corresponding to v(s) is calculated in step 406. The covariance matrix V(s) can be represented as follows:

V(s)=C(s)P₂(s)C^{T}(s)+R(s) (7)

where P₂(s) is a statistical matrix, most preferably a covariance matrix, of the state vector x₂(s). Similar to the state vector, the value of the matrix P₂(s) is dependent on the decision step 414. If the process 40 is performed on a leaf node, the matrix P₂(s) is an identity matrix (also shown in step 416). If the process 40 is performed on a parent node, the matrix P₂(s) is a calculated matrix (also shown in step 418). The calculated matrix P₂(s) is calculated by the process 50 as will he subsequently described.

The matrix P₂(s) is of size p by p. In the context of this document, the term “identity matrix” generally refers to a matrix with equal number rows and columns, with elements along the main diagonal being equal to one, and all other elements equal to zero. The matrix R(s) is a statistical matrix of size m by m. Most preferably R(s) is the covariance matrix of “measurement noise” when performing the process 40. The matrix R(s) is preferably an m by m identity matrix multiplied by a noise factor δ. The noise factor is a design parameter, and is preferably chosen based in part on the desired accuracy of the resultant solution to the approximated linear system of equations. Preferably, the order of magnitude of δ is roughly half the order of magnitude of the desired accuracy. The accuracy is a direct result of the magnitude of the residual vector r. For example, if the residual vector r has a magnitude preferably less than 10⁻¹⁴, than the noise factor δ is preferably chosen to be approximately 10⁻⁷. As should be apparent, the matrix V(s) is also of size m by m.

With continued reference to FIG. 4, subsequent to step 406, a “gain matrix” K(s) is calculated in step 408. The gain matrix K(s) can be represented as follows:

K(s)=P₂(s)C^{T}(s)V⁻¹(s) (8)

where V⁻¹(s) is the inverse of V(s). The gain matrix K(s) is of size p by m. Based on the gain matrix K(s), an updated state vector x(s) is calculated in step 410. The updated state vector x(s) is of the same size as the initial state vector x₂(s), namely size p by 1. The updated state vector x(s) can be represented follows:

x(s)=x₂(s)+K(s)v(s) (9)

Finally, as updated covariance matrix P(s) corresponding to the updated state vector x(s) is calculated in step 412. Matrix P(s) can be represented as follows:

P(s)=(I−K(s)C(s))P₂(s) (10)

where the matrix I is a p by p identity matrix. As should be apparent, the updated covariance matrix P(s) is of size p by p.

As a result of the process 40, the leaf nodes are solved by calculating the updated state vector x(s) and the updated covariance matrix P(s). As will subsequently be discussed, these updated vectors and matrices are used to predict the solutions to the parent nodes of the leaf nodes and to the parent nodes of other child nodes.

Refer now to FIG. 5, an exemplary process 50 for carrying out the process of step 108. Similar to the process 40, the process 50 is herein described for a single parent node s for which all of the child nodes of the parent node s have been solved. Suppose that the parent node s has q child nodes, which have been updated by the process 40. For the purposes of this document, the child nodes of the predict node s are referred to as child nodes s₁, s₂, s₃ . . . s_{q}. The goal of the process 50 is to predict state vectors x₁(s₁), x₁(s₂), x₁(s₃) . . . x₁(s_{q}) for the parent node s based on the updated state vectors x₁(s₁), x₁(s₂) . . . x(s_{q}) produced by process 40. The predicted state vectors arc of size p by 1, where p is the number of variables corresponding to the parent node s.

In step 502, the indices of the predicted state vectors x₁(s₁), x₁(s₂), x₁(s₃) . . . x₁(s_{q}) are determined. To determine the indices of the predicted state vector, the list of indices of variables common to the parent node s and each of the child nodes s₁, s₂, s₃ . . . s_{q} is compiled. In a non-limiting implementation, each predicted state vector is initialized to the all zero vector. Looking at the variables of the parent node s, the indexed location of each of the parent variables in the child node s₁ is returned and entered in the index predicted state vector for the child node s₁. This process is continued for the remaining child nodes s₂, s₃ . . . s_{q}. Based on the indices determined in step 502, the predicted state vectors x₁(s₁), x₁(s₂), x₁(s₃) . . . x₁(s_{q}) are determined in step 504.

With reference to FIG. 2, an example of the determining the above mentioned predicted state vectors is described. Suppose the parent node s corresponds to the node 230A. There are two child nodes in this example, and as such q=2. The child node s₁ and s₂ correspond to the child nodes 240A and 240B, respectively. Suppose a variable vector x is of length twelve. The variable vectors can be written as x=(x₀x₂x₃x₄x₅x₆x₇x₈x₉x₁₀x₁₁). Suppose further that the parent node s corresponds to variables (x₅x₁₁x₁₀), while the child node s₁ corresponds to the variables (x₆x₈x₁₀x₁₁) and the child node s₂ corresponds to the variables (x₇x₉x₁₀x₁₁). The positions of the shared variables between the parent node s and the child node s₁ are used to construct the predicted state vector x₁(s₁). The variable in the 0^{th} position of the parent node s does not appear in the child node s₁. As such, the 0^{th} position of x₁(s₁) remains zero. The variable in the 1^{st} positon of the parent node s appears in the 3^{rd} position of the child node s₁. As such, the 1^{st} position of x₁(s₁) corresponds to the 3^{rd} position of x(s₁). The variable in the 2^{nd} position of the parent node s appears in the 2^{nd} position of the child node s₁. As such, the 2^{nd} position of x₁(s₁) corresponds to the 2^{nd} position of x(s₁). Therefore, the predicted state vector x₁(s₁) can be written as

x₁(s₁)=(0, x(s₁)(3), x(s₁)(2)).

The same process can be carried out for the predicted state vector x₁(s₂), which also yields the same predicted state vector as x₁(s₁).

With continued reference to FIG. 5, statistical matrices, most preferably covariance matrices, corresponding to the predicted state vectors are generated in step 506. Specifically, the covariance matrix P₁(x₁(s₁)) corresponds to x₁(s₁), the covariance matrix P₁(x₁(s₂)) corresponds to x₁(s₂), and so on. The generated predicted covariance matrices fall out naturally from the child node updated covariance matrices P(s₁), P(s₂), P(s₃) . . . P(s_{q}) from step 412. For a given child node, for example child node s₁, the rows and columns corresponding to the common variables of the child node and the parent node s are placed in the predicted covariance matrix P₁(x₁(s₁)) corresponding to the list of indices of variables common to the parent node s and the child node S₁. All other elements of the predicted covariance matrix P₁(x₁(s₁)) are zero, with the exception of elements along the main diagonal, which are set to 1.

Recall die above example for which the index vector of x₁(s₁) is (0 3 2). As such, P₁(x₁(s₁)) is a 3 by 3 matrix. In a non-limiting implementation, P₁(x₁(s₁)) is initialized to a 3 by 3 matrix of all zeroes. The appropriate elements of the updated covariance matrix. P(s₁) are chosen for P₁(x₁(s₁)) based on the index vector outer product (0 3 2)^{T}(0 3 2). As a result, all of the elements in the 0^{th} row P₁(x₁(s₁)) are equal to zero. All of the elements in the 0^{th} column of P₁(x₁(s₁)) are equal to zero, except for the element with the indices (0, 0), which, is set to 1. The element in the 1^{st} row and 1^{st} column of P₁(x₁(s₁)) is equal to the element in the 3^{rd} row and 3^{rd} column of P(s₁). The element in the 1^{st} row and 2^{nd} column of P₁(x₁(s₁)) is equal to the element in the 3^{rd} row and 2^{nd} column of P(s₁). The element in the 2^{nd} row and 1^{st} column of P₁(x₁(s₁)) is equal to the element in the 2^{nd} row and 3^{rd} column of P(s₁). The element in the 2^{nd} row and 2^{nd} column of P₁(x₁(s₁)) is equal to the element in the 2^{nd} row and 2^{nd} column of P(s₁).

In step 508, the covariance matrices of the child nodes s₁, s₂, s₃ . . . s_{q} predicted in step 506 are combined into a single covariance matrix of the parent node s, written as P₂(s). The matrix P₂(s), is the same matrix described in the process 40. However, the matrix resulting from step 508 is a matrix used for updating a parent node, not the leaf nodes. Accordingly, the combined matrix is used as input to step 404. The combined covariance matrix can be represented as follows:

P₂(s)=(I+Σ(P₁⁻¹(s₁)−I))⁻¹ (11)

where the summation is carried out over the index of the child nodes (i=1, 2, 3 . . . q).

In step 510, the state vectors of the child nodes s₁, s₂, s₃ . . . s_{q} predicted in step 504 are combined into a single state vector of the parent node s, written as x₂(s). The vector x₂(s), is the same as the vector described in the process 40. However, the vector resulting from step 510 is a vector used for updating a parent node, not the leaf nodes. Accordingly, the combined state vector is used as input to step 404. The combined state vector can be represented as follows:

x₂(s)=P₂(s)ΣP₁⁻¹(sᵢ)x₁(sᵢ) (12)

where the summation is carried out over the index of the child nodes (i=1, 2, 3 . . . q).

As previously mentioned, step 108 is repeated until the root node has been solved. Once the root node has been solved, the solution of the root node is propagated down to each of the child nodes in the tree (step 110).

Let \dot{x}(s₀) represent state vector of the root node s₀. The updated state vector of the root node s₀ is propagated from the roof node to each of the child nodes of the tree. The propagation adjusts the predicted state vectors of the child nodes of the root node. Once the child nodes of the root node are adjusted, the same process is carried out for the child nodes of the children of the root node and so on, until all of the leaf nodes have been adjusted.

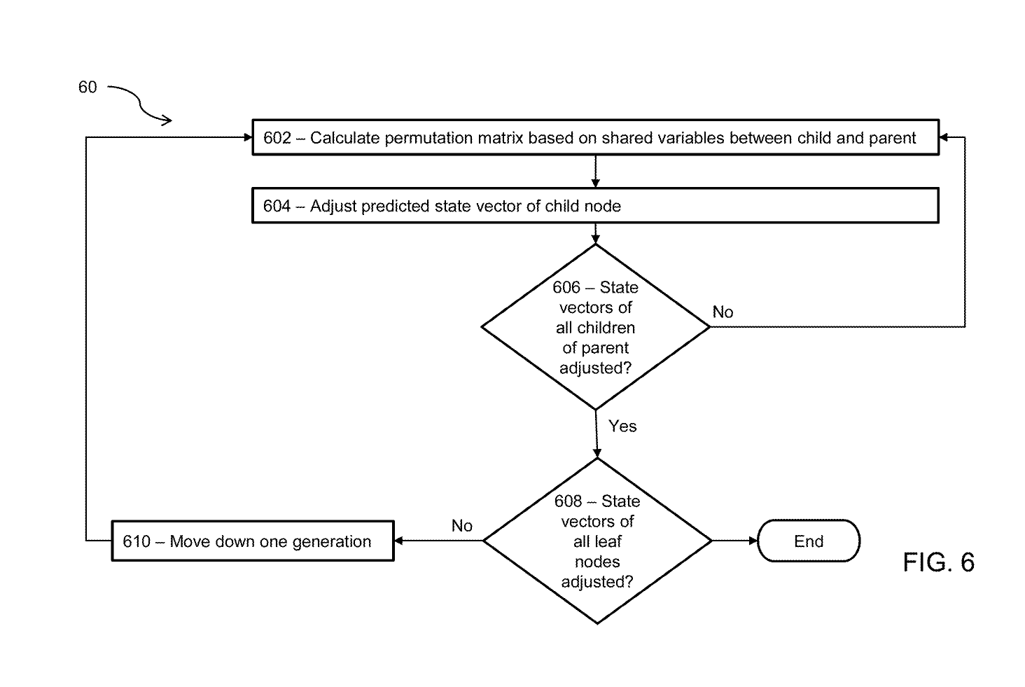

Refer now to FIG. 6, a flowchart of an exemplary process 60 for carrying out the process of propagation as described in step 110. Suppose that the nodes s₁, s₂, s₃ . . . sₘ are the child nodes of the root node s₀. In step 604, for each of the child nodes of the parent node, an adjustment factor is applied to the predicted state vectors x(s₁), x(s₂), x(s₃) . . . x(sₘ) obtained step 504 and the updated state vectors x(s₁), x(s₂), x(s₃) . . . x(sₘ) produced by the process 40. For a child node sᵢ, an adjusted state vector \dot{x}(sᵢ) can be expressed as follows:

\dot{x}(sᵢ)=x(sᵢ+J(sᵢ)(\dot{x}(s₀)−x₁(s₁)) (13)

where the matrix J(sᵢ) is a function of the updated covariance matrix P(sᵢ) and the inverse of the predicted covariance matrix P₁(s₁). Specifically, each matrix J(sᵢ) can be expressed as follows:

J(sᵢ)=P(sᵢ)F^{T}(sᵢ)P₁⁻¹(sᵢ) (14)

where the matrix F(sᵢ) is an index matrix. In a non-limiting implementation, the element in the i^{th} row and j^{th} column of the matrix F(sᵢ) is equal to 1 if and only if the i^{th} index of the state vector of node sᵢ and the j^{th} index of the state vector of the parent node of the sᵢ correspond to a common variable. All other elements of the matrix F(sᵢ) substantially zero.

The matrix can be thought of as a permutation matrix, or an adjustment matrix, which permutes the elements of the predicted covariance matrix P₁(sᵢ) based on the shared variables between the child node sᵢ and the parent node of the child node sᵢ. As should be apparent, the matrix j(sᵢ) is calculated in step 602 prior to step 604.

Steps 602 and 604 are repeated for the child nodes of the given parent node (initialized as the root node) until all of the state vectors of the child nodes of the parent node have been adjusted. This is depicted in a decision step 606. Once all of the state vectors of the child nodes of the parent node have been adjusted, the process 60 moves down one generation as shown in step 601. Note that if all of the state vectors of the leaf nodes have been adjusted, the process 60 is necessarily executing steps 602 and 604 at the nodes of the youngest generation of the tree, and as such, cannot move down another generation upon completion of step 604. This implies that all of the state vectors of the nodes of the tree have been adjusted. Once the state vectors of the leaf nodes have been adjusted, the process 60 ends. Checking whether the state vectors of the leaf nodes have been adjusted is depicted in a decision step 608. The adjusted state vectors of the nodes provide the solution to the approximated linear system of equations.

Recall that the accuracy of the resultant solution is based in part on the noise factor δ. If the resultant accuracy does not satisfy an accuracy condition, the steps 106-110 are repeated. This is depicted by decision step 111. This is typically accomplished by calculating a new residual vector and subtracting the resultant solution from the new residual vector. The resultant subtracted difference is typically normalized. As such, the process is iterative based on the solutions to the approximated linear system of equations. In certain exemplary non-limiting implementations of the process 10 for CAD systems, the number of iterations is typically in the range of 2-5 iterations.

Once the resultant linear accuracy condition is satisfied (step 111), the accuracy of the resultant solution to the non-linear system of equations is checked. Recall that the above solution is the solution to the first iterative step in the linear approximation. As such, if the accuracy of the residuals of the non-linear system of equations does not satisfy an accuracy condition, the steps 102-111 are repeated. This is depicted in a decision step 124. In certain exemplary non-limiting implementations of the process 10 for CAD systems, the number of iterative steps for the linear approximation is in the range of 2-4 iterative steps. As a result, the process is preferably implemented as a dual iterative process, where the iterations of the linearization step have 2-5 sub-iterations.

Completion of all iterations results in a configuration of the model in which the constraints as applied to the entities are satisfied. As such, the variables corresponding to the entities are produced for output. In the non-limiting implementation of the process 10 for CAD systems, this entails outputting the updated values of the variables of all of the entities.

Refer now to FIG. 7A, a high-level partial block diagram of an exemplary system 70 configured to implement solving the system of equations according to the present invention. The system (processing system) 70 includes a processor 702 (one or more) and four exemplary memory devices: a RAM 704, a boot ROM 706, a mass storage device (hard disk) 708, and a flash memory 710, all communicating via a common bus 712. As is known in the art, processing and memory can include any computer readable medium storing software and/or firmware and/or any hardware element(s) including but not limited to field programmable logic array (FPLA) element(s), hard-wired logic element(s), field programmable gate array (FPGA) element(s), and application-specific integrated circuit (ASIC) element(s). Any instruction set architecture may be used in processor 702 including but not limited to reduced instruction set computer (RISC) architecture and/or complex instruction set computer (CISC) architecture. A module (processing module) 714 is shown on the mass storage device 708, but as will be obvious to one skilled in the art, could be located on any of the memory devices.

The mass storage device 708 is a non-limiting example of a non-transitory computer-readable storage medium bearing computer-readable code for implementing the solving methodology described herein. Other examples of such computer-readable storage media include read-only memories such as CDs hearing such code.

The system 70 may have an operating system stored on the memory devices, the ROM may include boot code for the system, and the processor may be configured for executing the boot code to load the operating system to the RAM 704, executing the operating system to copy computer-readable code to the RAM 704 and execute the code.

The network connection 720 provides communications to and from the system 70. Typically, a single network connection provides one or more links, including virtual connections, to other devices on local and/or remote networks. Alternatively, the system 70 can include more than one network connection (not shown), each network connection providing one or more links to other devices and/or networks. The system 70 can be implemented as a server or client respectively connected through a network to a client or server.

The embodiments disclosed herein may be provided as a computer program product, or software, that may include a machine-readable medium (or computer-readable medium) having instructions stored thereon, which may be used to program a computer system, such as, for example, the system 70, to perform a process or processes according to the embodiments disclosed herein. In embodiments directed to CAD systems, the computer program product, or software, may be implemented as a plug-in for existing CAD software programs.

Note that the system 76 may be implemented as part of a computer system 700 including a display 72, a user input device 74, and a display organizing module 76, as shown in FIG. 7B. The display 72 may be any suitable type of display for displaying data output from the system 70, including, but not limited to, a computer monitor and an LCD screen. The user input device 74 may be any type of device suitable for allowing a user to provide commands to the system 70, including, but not limited to, a keyboard and a mouse. Alternatively, the system 70 may be implemented as a stand-alone computer system including the display 72, the input user device 74, and the display organizing module 76.

The types of commands provided to the system 70 via the user input device 74 allow for a user to instruct the system 70 to perform actions including, but not limited to, generating models, modifying models, saving models and loading models. As such, the user may generate a model and the corresponding entities and constraints. Subsequently, the user may modify the entities, resulting in related entities being properly adjusted based on the solving of the constraint equations. Furthermore, generated models may be in memory, such as the flash memory 710, and may be subsequently loaded from memory to enable modification and manipulation by the user via the user input device 74.

As previously mentioned, subsequent to completion of all iterations, the variables of the entities are produced for output. The display organizing module 76 organizes the output entities for display, as shown in step 116. The organized output entities are provided to the display 72 for visualization by the user. Providing the display organizing module 76 corresponds to step 114. The output entities may alternatively be stored to a third party device or displayed via a third party display device.

In order to better explain the embodiments presented herein, an example for solving a system for two-dimensional geometric entities is provided. The intent of the example provided is to illustrate in more detail the steps in the process 10 for solving a system of equations. Note, that the variables of the entities are preferably floating point data types, and most preferably double precision data types. For convenience, the values of many of the variables and matrices in the example described herein are shown only to four decimal places, with the several exceptions showing greater decimal precision. In the provided example, the noise factor δ is chosen as having a value of 10⁻⁸.

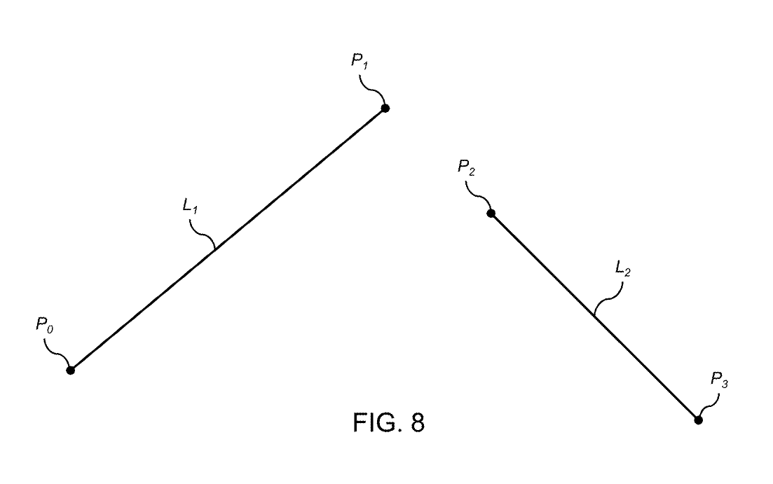

Refer now to FIG. 8, a first line segment L₁ and a second line segment L₂. The line segment entities L₁ and L₂ are constrained by a single constraint, namely perpendicularity. As shown in FIG. 8, line segment L₁ is defined by two end points in Cartesian coordinates: P₀(10, 7.5) and P₁ (17.5, 12.5). Similarly, line segment L₂ is defined by two end points in Cartesian coordinates: P₂ (20, 10) and P₃ (25, 5). As should be apparent, in the initial configuration of the line segments, the line segments, are not perpendicular.

Based on the above entities, a variable vector is generated. The initial vector includes eight variables: P₀(x₀, y₀), P₁(x₁, y₁), P₂(x₂, y₂) and P₃(x₃, y₃). As previously mentioned, perpendicularity constraints may be more easily solved by using combination of Cartesian and polar coordinates. As such, each line segment has a magnitude (length) and angle. Line segment L₁ has magnitude d₀(9.0139) and angle a₀(0.5880). Line segment L₂ has magnitude d₁(7.0711) and angle a₁(−0.7854). This yields a total of twelve variables for the two entities. The entities are expressed as the following system of non-linear equations:

x₁=x₀+d₀ cos a₀ (15)

y₁=y₀+d₀ sin a₀ (16)

x₃=x₂+d₁ cos a₁ (17)

y₃=y₂+d₁ sin a₁ (18)

Adding the perpendicularity constraint adds a fifth equation to the above system of equations. The perpendicularity constraints can be represented as follows:

a₁−a₀=−π/2 (19)

The vector of variables z is expressed as

z=(x₀ y₀ x₁ y₁ d₀ a₀ x₂ y₂ x₃ y₃ d₁ a₁)=(z₀ z₁ z₂ z₃ z₄ z₅ z₆ z₇ z₈ z₉ z₁₀ z₁₁).

The initial values of the variables are used as the initial guess vector z⁰, and as such is written as:

z⁰=(10 7.5 17.5 12.5 9.0139 0.5880 20 10 25 5 7.0711 −0.7854).

As previously mentioned, normalizing is accomplished by dividing by the maximum absolute value of the values of the initial guess vector, which is the present example is 25. Normalization results in the following vector:

z=(0.4 0.3 0.7 0.5 0.3606 0.5880 0.8 0.4 1.0 0.2 0.2828 −0.7854).

Note that the angle variables are not normalized.

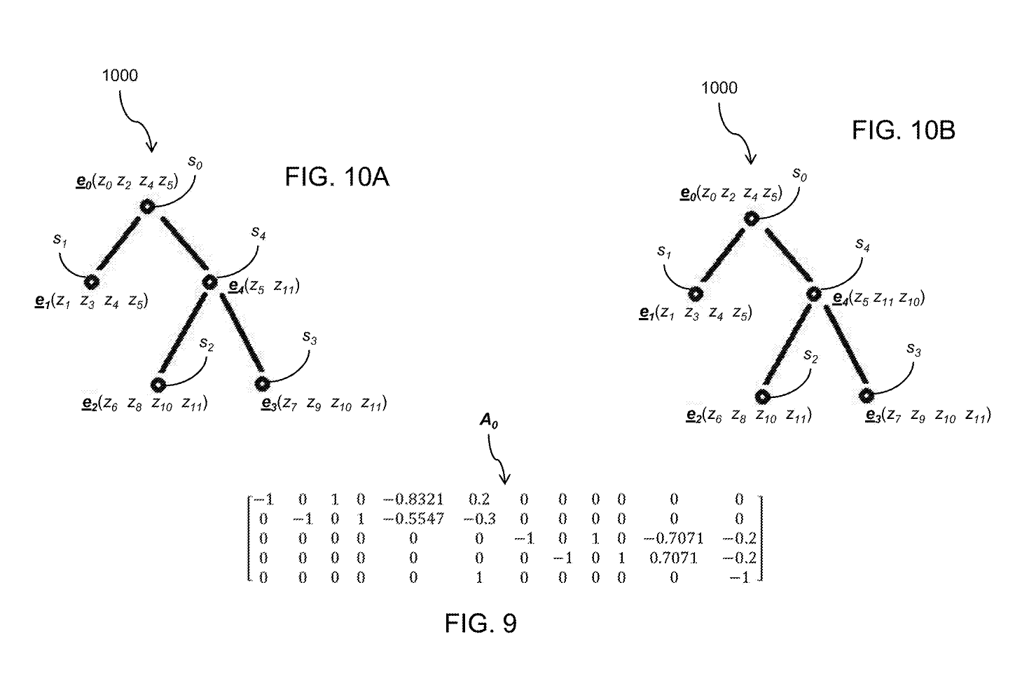

The matrix A⁰ is generated using the results of expression (2) to linearize the above normalized nonlinear equations. The generated matrix A⁰ is shown in FIG. 9. As a result, a system of five linear equations with twelve variables obtained. Note that the matrix A⁰ is recognized to be sparse row-wise in that the first four rows have four non-zero elements and the last row has two non-zero elements. As should be apparent, the initial output vector y⁰ is given by y⁰=(0.1176 −0.1764 0.1571 0.1571 1.5708)^{T}. The resulting residual vector is r⁰=(0 0 0 0 −0.19739555984988089)^{T}.

Referring to FIGS. 10A and 10B, the process 30 is used to construct a tree 1000. For simplicity, the equation in the 0^{th} row of A⁰ is placed in the root node s₀. No other equations are placed in the root node. The equation in the root node is denoted e₀(z₀ z₂ z₄ z₅). Equations e₁(z₁ z₃ z₄ z₅) and e₄(z₅ z₁₁) share variables in common with the variables of the root node. As such, equations e₁(z₁ z₃ z₄ z₅) and e₄(z₅ z₁₁) are placed in the child nodes s₁ and s₄, respectively. The node s₁ does not have any children. The node s₄ has two child nodes: s₂ and s₃. Equations e₂(z₆ z₈ z₁₀ z₁₁) and e₃(z₇ z₉z₁₀ z₁₁) are placed in nodes s₂ and s₃, respectively.

As should be apparent, there is a collision with respect to the nodes s₂, s₃, and s₄. Since the variable z₁₀ appears in the equations of the child nodes s₂ and s₃ but does not appear in the parent node, the variable is added to the parent node s₄ as shown in FIG. 10B, according to step 320 of the tree generating process 30 previously described. As should be apparent, the leaf nodes are the nodes s₁, s₂, and s₃.

Upon completion of the construction of the tree 1000, the steps of process 40 are executed to update the leaf nodes s₁, s₂ and s₃. The measurement matrix C(s₂) for the node s₂ is the 2^{nd} row of A⁰ with the zeroes removed, and can be expressed as C(s₂)=(−1 1 −0.7071 −0.2).

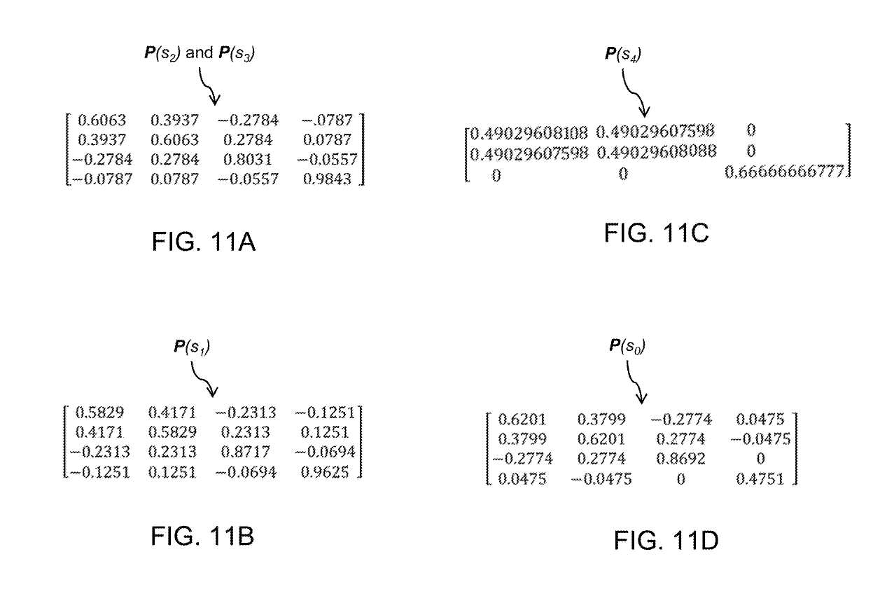

Using equations (6)-(10), the following matrices and vectors are calculated: x₂(s₂)=(0 0 0 0), y(s₂)=0, v(s₂)=0, V(s₂)=2.5400+δ, K(s₂)=(−0.3937 0.3937 −0.2784 −0.0787)^{T}, and X(s₂)=(0 0 0 0). The matrix P(s₂) is represented as shown in FIG. 11A. The calculations for the node s₃ result in the same vectors and matrices as for the node s₂ above.

Similar calculations are made with respect to the node s₁. The measurement matrix, for the node s₁ is the 1^{st} row of A⁰ with the zeroes removed, and can be expressed as C(s₁)=(−1 1 −0.5547 −0.3).

Using equations (6)-(10), the following matrices and vectors are calculated x₂(s₁)=(0 0 0 0), y(s₁)−0, v(s₁)=0, V(s₁)=2.3977+δ, K(s₁)=(−0.4171 0.4171 −0.2313 −0.1251)^{T}, and X(s₁)=(0 0 0 0). The matrix P(s₁) is represented as shown in FIG. 11B.

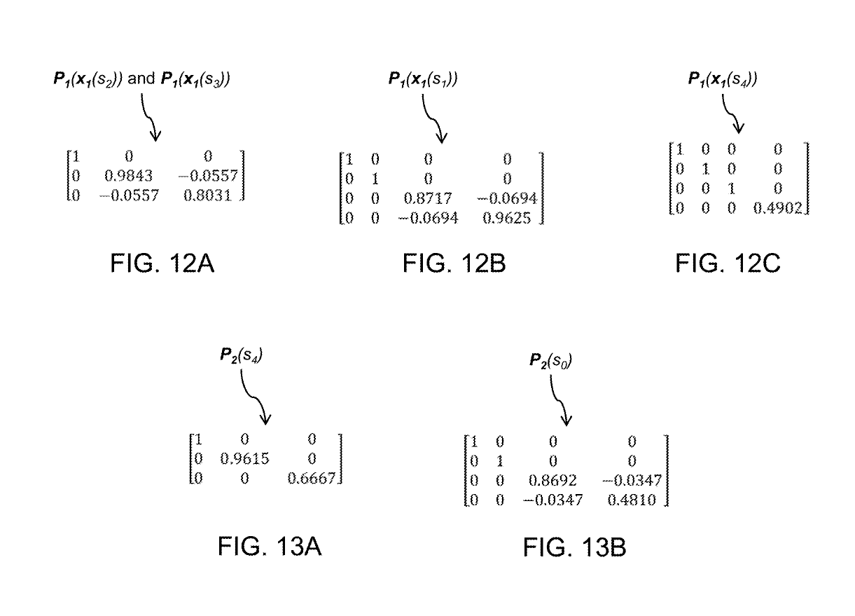

The steps of the process 50 are executed to predict the state vectors and covariance matrices. Since the updated state vectors (s₂) and x(s₃) are zero vectors, the predicted state vectors x₁(s₂)=(0 0 0) and x₂(s₃)=(0 0 0). The predicted covariance matrices P₁(x₁(s₂)) and P₁(x₁(s₃)) are identical and are shown in FIG. 12A.

Using equations (11) and (12), the combined covariance matrix and combined state vector of the node s₄ are calculated. Accordingly, x₂(s₄)=(0 0 0). The combined covariance matrix P₂(s₄) is shown in FIG. 13A.

Now the steps of the process 40 are executed to update the node s₄. The measurement matrix for the node s₄ can be expressed as C(s₄)=(−1 1 0).

Using equations (6)-(10), the following matrices and vectors are calculated: y(s₄)=−0.19734, v(s₄)=−0.1974, K(s₄)=(0.5098 −0.4901 0)^{T}, and x(s₄)=(−0.1006 0.0968 0). The matrix P(s₄) is represented as shown in FIG. 11C. The matrix P(s₄) is shown with higher decimal precision to highlight the fact that the matrix P(s₄) is nearly singular since the first two rows of P(s₄) are nearly equal. However, the matrix P(s₄) is not singular, and therefore a matrix inverse can be calculated.

The non-singularity of the matrix P(s₄) and all such updated covariance matrices, is due to the noise factor δ as will be explained in subsequent sections of the description.

The steps of the process 50 are executed to predict the state vector and covariance matrix based on the node s₁. Since the updated state vector x(s₁) is a zero vector, the predicted state vector x₁(s₁)=(0 0 0). The predicted covariance matrices P₁(x₁(s₁)) is shown in FIG. 12B.

Similarly, the steps of the process 50 are executed to predict the state vector and covariance matrix based on the node s₄. Since the updated state vector x(s₄) is non-zero, the resulting predicted state vector x₁(s₄)=(0 0 0 −0.1006). The predicted covariance matrix P₁(x₁(s₄)) is shown in FIG. 12C.

Using equations (11) and (12), the combined covariance matrix and combined state vector of the root node s₀ is calculated. Accordingly, the combined state vector x₂(s₀) is calculated as x₂(s₀)=(0 0 0.0071−0.0987). The combined covariance matrix P₂(s₀) is shown in FIG. 13B.

Finally, the steps of the process 40 are executed to update the root node s₀. The measurement matrix for the node be written as C(s₀)=(−1 1 −0.8321 0.2).

Using equations (6)-(10), the following matrices and vectors are calculated: y(s₀)=0, V(s₀)=0, V(s₀)=2.6325+δ, K(s₀)=(−0.3799 0.3799 −0.2774 0.0475)^{T}, and \dot{x}(s₀)=(−0.00975255962702836 0.00975255962702836 0 −0.0975255967579119). The matrix P(s₀) is shown in FIG. 11D.

At this stage, the root node s₀ has been updated, and the process of propagating the updated state vectors of all of the nodes down to the leaf nodes can begin. Accordingly, the steps of the process 60 are executed to facilitate the aforementioned propagation.

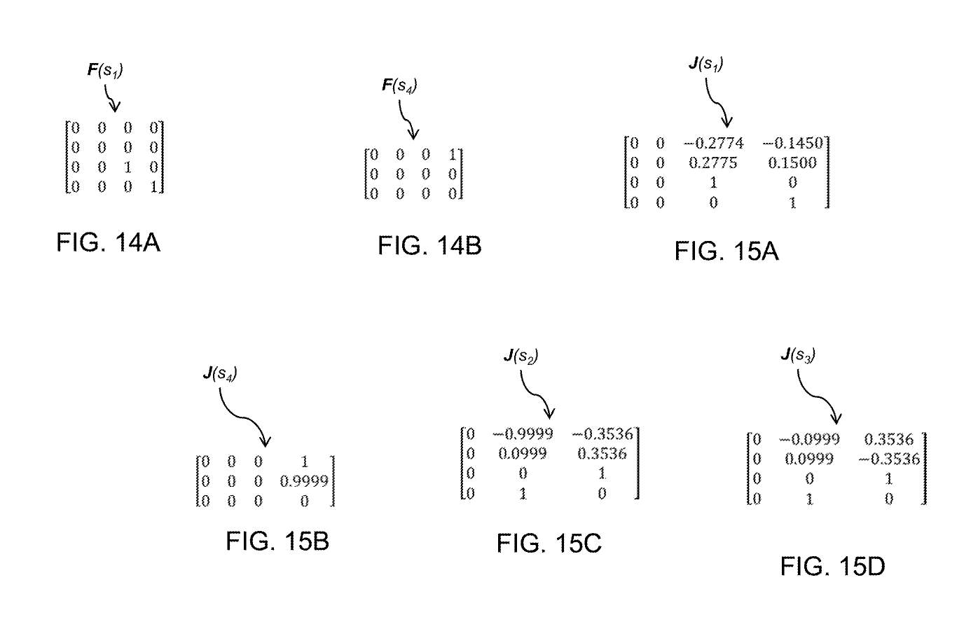

Initially, the updated state vector of the root node s₀ is propagated to the child nodes s₁ and s₄. As previously described, the matrices F(s₁) and F(s₄) are determined based on the common indices of the child nodes and the parent node. The matrices F(s₁) and F(s₄) and are shown in FIGS. 14A and 14B, respectively.

Using equation (14), the matrices J(s₁) and J(s₄) are calculated as shown in FIGS. 15A and 15B, respectively.

Using equation (13), the adjusted state vector \dot{x}(s₁) can be expressed as \dot{x}(s₁)=(0.0146288394405426 −0.0146288394405426 0 −0.0975255967579119).

The calculation of the adjusted state vector \dot{x}(s₄) is not shown for convenience. The adjusted state vector \dot{x}(s₄) is propagated to the leaf nodes s₂ and s₃. Using equation (14), the matrices J(s₂) and J(s₃) are calculated as shown in FIGS. 15C and 15D, respectively.

Finally, using equation (13), the adjusted state vectors \dot{x}(s₂) and \dot{x}(s₃) are calculated. The calculations yield \dot{x}(s₂)=(−0.00998699615539714, 0.00998699615539714, 0, 0.0998699620533214) and \dot{x}(s₃)=(−0.00998699615539715, 0.00998699615539715, 0, 0.0998699620533214).

Collecting all of the values of the variables from the solved state vectors \dot{x}(s₀), \dot{x}(s₁), \dot{x}(s₂), \dot{x}(s₃), and \dot{x}(s₄), as should be apparent, the vector z¹=(−0.00975255962702836 0.014628839440542553 0.00975255962702836 −0.014628839440542553 0 −0.097525596757911864 −0.0099869961553971276 −0.00998699615539715 0.0099869961553971376 0.00998699615539715 0 0.099869962053321423). Taking the difference between the normalized initial guess vector z⁰ and z¹ yields z=(0.40975255962702839 0.28537116055945744 0.69024744037297159 0.51462883944054261 0.3605551275463989 0.68552820030547934 0.80998699615539715 0.40998699615539719 0.99001300384460289 0.19001300384460287 0.282842712474619 −0.88526812545076972).

Calculating the new residual vector yields r=(0.000000000097525584830115974 −0.00000000014628834255070444 0.0000000000998400011578535 0.000000000099869973402277878 −0.0000000010386473903167825).

The norm of the new residual vector is of the order of 10⁻⁹, which as mentioned earlier, is not as accurate as desired for typical CAD systems. Accordingly, the “No” branch of decision step 111 is selected, thus repeating steps 106 and 108. Repeating steps 106 and 108 produces a new residual vector with norm on the order of 10⁻¹⁸, which, as previously mentioned, is of sufficient accuracy for most typical CAD systems.

Recalling that the above solution is based on the iteration of the linear approximation to the non-linear system of equations, the norm of the residual vector of the non-linear system of equations is calculated. Accordingly, the norm of such a vector is on the order of 10⁻³, which is not as accurate as desired for most typical CAD systems. Accordingly, the “No” branch of decision step 124 is selected, thus repeating steps 106 and 108 (step 104 can be skipped since the tree 1000 was already generated). The second iteration of the linear approximation to the non-linear system of equations yields a residual vector norm on the order of 10⁻¹⁰, which may still not be as accurate as desired. Accordingly, the “No” branch of decision step 124 is selected again, thus repeating steps 106 and 108. The third iteration of the linear approximation to the non-linear system of equations yields a residual vector norm on the order of 10⁻¹⁷, which is within the typical desired accuracy for many typical CAD systems. Accordingly, the “Yes” branch of decision step 124 is selected, ending the computation steps of the process 10.

As previously mentioned, the noise factor δ is a design parameter preferably chosen based in part on the desired accuracy of the process 10. Note that the updated covariance matrices calculated by the process 40 are maintained as non-singular matrices due to the chosen value of the noise factor δ. As previously mentioned with reference to matrix P(s₄) in FIG. 11C, the matrices may be nearly singular. In fact, if noise factor values which are too small are chosen, the updated covariance matrices would become singular, causing the process 10 to end after a single iteration.

Note that although an the process as described thus far has pertained to an exemplary embodiment for determining a configuration of a model having geometric entities as applied to CAD systems, other embodiments are possible in which the entities are non-geometric entities. Such embodiments are of value in a variety of industrial applications, and may be of particular value in operations research problems. An example of such an applicable operations research problem is location selection. Such operations research problems involve the location of facilities, such as warehouses and the like, for supplying demand to a set of customers. For each customer, there is an associated cost of supplying the customer from a facility location. The goal of the location selection problem is to choose a subset of locations at which to establish facilities, and then to assign each customer to a facility, in order to reduce total cost. Accordingly, the constraints of such a problem ensure that all customers are supplied from one of the facilities and prevent any customers from being assigned to a location lacking a facility.

Other examples of applicable operations research problems include, but are not limited to, job scheduling problems in machine production industries, automobile manufacture sequencing problems, vehicle routing problems, and crew metering for air travel.

Additionally, the process described herein, may be of particular value in industrial optimization problems for resource distribution, such as, for example, the distribution of gas from multiple sources to multiple consumers through a pipelined network. In such a resource distribution problem, the gas may be redistributed at each consumer point in the network. Accordingly, the constraints of such a problem are defined by the redistribution of gas. Such Problems may also be solved using a linear programming simplex method which is reliant on the inversion of large matrices. The inversion of matrix having n rows and n columns can be considered as solving n systems of equations, each system of equations having n variables and n equations. Accordingly, the above mentioned resource distribution problem may be solved by directly applying the process described herein to invert the matrices required by the simplex method.

It will be appreciated that the above descriptions are intended only to serve as examples, and that many other embodiments are possible within the scope of the present invention as defined in the appended claims.

What is claimed is:

1. A method for determining a configuration of a model comprising a collection of entities satisfying a set of constraints, the method comprising:
(a) providing the collection of entities and the set of constraints, the collection of entities represented by a plurality of variables, each constraint corresponding to at least one constraint equation interrelating a subset of the plurality of variables;
(b) generating at least one tree, the at least one tree including a plurality of nodes, the at least one tree including a root node, the root node having at least one child node, the nodes having at least one child node defining parent nodes, the nodes lacking child nodes defining leaf nodes, each node corresponding to a subset of the constraint equations;
(c) for a subset of leaf nodes, solving in parallel to satisfy the constraint equations of each of the leaf nodes;
(d) for each parent node for which the constraint equations of the child nodes have been satisfied, solving to satisfy the constraint equations of the parent node, based on the satisfied constraint equations of the corresponding child nodes;
(e) repeating (d) until the constraint equations of the root node have been satisfied;
(f) propagating the satisfied constraint equations of each of the parent nodes to the corresponding child nodes of each parent node, thereby determining the configuration of the model satisfying the set of constraints; and
(g) outputting the entities corresponding to the determined configuration.

2. The method of claim 1, further comprising:
(h) providing a display organization module; and
(i) organizing for display the output entities corresponding to the determined configuration of the model according to the satisfied set of constraints,

3. The method of claim 1, wherein solving to satisfy the constraint equations of each of the child nodes includes:
(i) updating a state vector of the child node; and
(ii) generating an updated statistical matrix corresponding to the updated state vector.
4. The method of claim 3, wherein updating the state vector of each of the child nodes is based on a difference between a first configuration, in which the constraint equations corresponding to the child node are not satisfied, and a second configuration, in which the constraint equations corresponding to the child node are satisfied.

5. The method of claim 3, wherein satisfying the constraint equations of each parent node includes:
(i) predicting a state vector for each of the child nodes of the parent node, each state vector corresponding to the updated state vector of each child node of the parent node; and
(ii) generating a predicted statistical matrix corresponding to each of the predicted state vectors.

6. The method of claim 5, wherein satisfying the constraint equations of each parent node further includes:
(iii) combining the predicted statistical matrices of the child nodes of the parent node into a single combined statistical matrix;
(iv) generating a combined state vector corresponding to the combined statistical matrix; and
(v) updating a state vector of the parent node based on the combined statistical matrix and combined state vector.

7. The method of claim 6, wherein propagating the satisfied constraint equations of each parent node includes:
(i) propagating the updated state vector of the parent nodes to each of the child nodes of the parent node to apply an adjustment to the updated state vectors of each of the child nodes of the parent node; and
(ii) repeating (i) until the updated state vectors of the leaf nodes are adjusted.

8. The method of claim 1, further comprising:
(h) repeating (c)-(f) until a first accuracy condition is satisfied.

9. The method of claim 8, wherein the repeating is iterative.

10. (canceled)

11. The method of claim 1, wherein the entities are geometric entities.

12. (canceled)

13. (canceled)

14. The method of claim 1, further comprising:
(h) generating a matrix representative of the model, the matrix having at least a first and second dimension, each of at least one vectors in the first dimension of the matrix corresponding to a subset of the plurality of variables, the matrix being sparse in the first dimension, each node of the at least one tree corresponding to at least one of the vectors in the first dimension of the matrix.

15. The method of claim 14, wherein the model is a non-linear
model.

16. The method of claim 15, wherein generating the matrix representative of the non-linear model includes:
(i) prior to (b), linearizing the non-linear model to produce a linear model; and
(ii) repeating (c)-(f) until a second accuracy condition is satisfied.

17. (canceled)

18. (canceled)

19. (canceled)

20. The method of claim 1, wherein generating the at least one tree includes:
(i) creating a root node of the at least one tree and placing at least one of the constraint equations in the root node; and
(ii) placing constraint equations sharing at least one variable with the at least one constraint equation in the root node in respective child nodes of the root node.

21. The method of claim 20, wherein generating the at least one tree further includes:
(iii) placing constraint equations sharing at least one variable with at least one of the constraint equations in the respective child nodes in additional respective child nodes of the respective child nodes;
(iv) repeating (iii) until each of the constraint equations is placed in at least one of the nodes of the at least one tree.

22. (canceled)

23. The method of claim 1, farther comprising:
(h) receiving as user input, instructions to modify at least one entity of the collection of entities; and
(i) in response to the user input, solving to satisfy the set of constraint equations to determine a new configuration of the model.

24. The method of claim 23, further comprising:
(j) outputting the entities corresponding to the configuration of the model satisfying the set of constraints.

25. The method of claim 1, wherein solving to satisfy the constraint equations of the parent node, based on the satisfied constraint equations of the corresponding child nodes is done in parallel.

26. (canceled)

27. (canceled)

28. (canceled)

29. (canceled)

30. (canceled)

31. A system for determining the configuration of a model comprising a collection of entities and a set of constraints in a computer having software instructions, the collection of entities represented by a plurality of variables, each constraint corresponding to at least one constraint equation interrelating a subset of the plurality of variables, the system comprising:
(a) a computer system, the computer system including a memory, at least one processor, at least one user input device, and at least one display device; and
(b) a computer generated model stored on the memory of the computer system, the computer system configured to:
(i) receive user input to modify at least one entity of the collection of entities via the at least one input device;
(ii) generate at least one tree, the at least one tree including a plurality of nodes, the at least one tree including a root node, the root node having at least one child node, the nodes having at least one child node defining parent nodes, the nodes lacking child nodes defining leaf nodes, each node corresponding to a subset of the collection of constraint equations;
(iii) for a subset of leaf nodes, solve in parallel to satisfy the constraint equations of each of the leaf nodes;
(iv) for each parent node for which the constraint equations of the child nodes have been satisfied, solve to satisfy the constraint equations of the parent, based on the satisfied constraint equations of the corresponding child nodes;
(v) repeat (iv) until the constraint equations of the root node have been satisfied;
(vi) propagate the satisfied constraint equations of each of the parent nodes to the corresponding child nodes of each parent node, thereby determining the configuration of the model satisfying the set of constraint;
(vii) output the entities corresponding to the determined configuration; and
(viii) display the output entities, via the at least one display device, of the determined configuration,

32. A non-transitory computer-readable storage medium having embedded thereon computer-readable code, the computer-readable code comprising program code for causing a suitably programmed system to determine a configuration of a model comprising a collection of entities satisfying a set of constraints, by performing the following steps when such program is executed on the system, the steps comprising:
(a) providing the collection of entities and the set of constraints, the collection of entities represented by a plurality of variables, each constraint corresponding to at least one constraint equation interrelating a subset of the plurality of variables;
(b) generating at least one tree, the at least one tree including a plurality of nodes, the at least one tree including a root node, the root node having at least one child, the nodes having at least one child node defining parent nodes, the nodes lacking child nodes defining leaf nodes, each node corresponding to a subset of the constraint equations;
(c) for a subset of leaf nodes, solving in parallel to satisfy the constraint equations of each of the leaf nodes;
(d) for each parent node for which the constraint equations of the child nodes have been satisfied, solving to satisfy the constraint equations of the parent node, based on the satisfied constraint equations of the corresponding child nodes;
(e) repeating (d) until the constraint equations of the root node have been satisfied;
(f) propagating the satisfied constraint equations of each of the parent nodes to the corresponding child nodes of each parent node, thereby determining the configuration of the model satisfying the set of constraints; and
(g) outputting the entities corresponding to the determined configuration.
